(19) United States
(12) Patent Application Publication
(10) Pub. No.: US 2012/0010930 A1
(43) Pub. Date: Jan. 12, 2012

(54) METHODS FOR AUTHENTICATING A PURCHASE USING LOCATION BASED MOBILE SERVICE

(76) Inventors: Graham Langdon, Santa Cruz, CA (US); Jitendra Gupta, Cupertino, CA (US)

(21) Appl. No.: 13/179,479

(22) Filed: Jul. 8, 2011

Related U.S. Application Data
(60) Provisional application No. 61/362,697, filed on Jul. 9, 2010.

(51) Int. Cl. G06Q 30/00

(52) U.S. Cl. 705/14.16; 705/14.33

(57) ABSTRACT

In various embodiments, a rewards program may provide users with rewards for transacting with a merchant. In various embodiments, the transactions are validated before a user is allowed to receive a reward. In various embodiments, a mobile device is used to validate a transaction. In various embodiments, a mobile device may store an indication of a user's progress towards earning a reward.

### RELATED APPLICATIONS

The present application claims the benefit of priority of U.S. provisional application no. 61/362,697, filed Jul. 9, 2010. The application is hereby incorporated by reference herein for all purposes.

### SUMMARY

Various embodiments include systems and methods for authenticating transactions and for providing rewards to participants in such transactions. Various embodiments include utilizing mobile devices to authenticate transactions.

### BRIEF DESCRIPTION OF THE DRAWINGS

FIG. 1 illustrates a system according to some embodiments.

FIG. 2 illustrates a program server according to some embodiments.

FIG. 3 illustrates a social network server according to some embodiments.

FIG. 4 illustrates a user mobile device according to some embodiments.

FIG. 5 illustrates a merchant device according to some embodiments.

FIG. 6 illustrates a user personal computer according to some embodiments.

FIG. 7 illustrates a user database according to some embodiments.

FIG. 8 illustrates a merchant database according to some embodiments.

FIG. 9 illustrates a rewards database according to some embodiments.

FIG. 10 illustrates a transaction database according to some embodiments.

FIG. 11 illustrates a user progress database according to some embodiments.

FIG. 12 illustrates a rewards card database according to some embodiments.

FIG. 13 illustrates means for authenticating a transaction according to some embodiments.

FIG. 14 illustrates a means for reporting a referral, according to some embodiments.

FIG. 15 illustrates a process flow, according to some embodiments.

### DETAILED DESCRIPTION

Various embodiments related to location based services for mobile devices. Various embodiments relate to methods for authenticating a location based check-in received from a mobile device. This service may allow merchants whose customers use location based mobile applications to validate that a customer was actually present and made a purchase. This may allow merchants to offer rewards using location based mobile applications and tie those rewards to actual purchases.

Conventional location based mobile services may have disadvantages in that they do not provide a way to authenticate business transactions between a customer and the business that they are interacting with using any location based mobile service.

It may be desirable for businesses to offer customers rewards for making a purchase. It may be desirable for businesses to use mobile devices to facilitate a reward system. In using mobile devices to facilitate such a reward system, it may be desirable for a business to authenticate with a mobile device that a transaction took place and that a purchase was actually made.

It may be desirable, in various embodiments, for businesses to use a location based mobile service to authenticate that a customer made a purchase.

Various embodiments provide methods and systems for authenticating a business transaction using a location based mobile service, so that a business may reward loyal customers. These methods may allow businesses to reward in real-time customers who make purchases.

In various embodiments business owners are provided with a method to authenticate a customer's purchase using a location-based mobile service. This process of authentication may enable a reliable program to reward loyalty on behalf of the customer.

Various embodiments comprise methods utilized after a customer makes a purchase to authenticate that purchase. Such methods may include authentication via 1.) an alphanumeric code, known only to business employees, that can be entered in the customer's mobile device after a purchase has been made; 2.) an RFID tag that can be presented to the customer after a purchase, which can communicate with the customers mobile phone and provide a key to authenticate a transaction has occurred; 3.) a QR code or barcode that can be presented to the customer after a purchase, that a customer can photograph with their mobile device to authenticate a transaction has taken place; 4.) a method of placing in proximity two phones, one owned by the business and one owned by the customer, such that their associated geolocation data can authenticate a purchase has been made; 5.) a method of photographing a receipt after a purchase has been made, and using that to authenticate that a purchase has been made; 6.) a wireless router, the code to which can be provided to the customer after a purchase, connecting to which will result in purchase authentication; 7.) a device that algorithmically displays a changing alphanumeric code that customers can only view after a purchase has been made, which provides in purchase authentication; and 8.) a near field communication (NFC) tag that can be presented to the customer after a purchase, which can communicate with the customer's mobile phone and provide a key to authenticate a transaction has occurred;

It is to be understood that various embodiments are not limited in their application to the details of construction and to the arrangements of the components set forth in the following description or illustrated in the drawings. Other modes of practice and other embodiments are contemplated. Also, it is to be understood that the phraseology and terminology employed herein are for the purpose of the description and should not be regarded as limiting.

Various embodiments provide a method of purchase authentication that will allow business owners to reward their customers' loyalty.

Various embodiments provide a method of purchase authentication that allow a business owner to know when a purchase has been made that is the result of a referral by another customer.

Turning now descriptively to the drawings, in which similar reference characters denote similar elements throughout the several views, the attached figures illustrate methods for authentication transactions using location based mobile services.

Various embodiments provide a function for a location based mobile service to authenticate a purchase at a businesses' physical location.

Various embodiments provide for tight integrations with a mobile application such that authentication can be received on a server, and used to properly issue rewards for customer purchases, customer loyalty and customer referrals.

Various embodiments may emulate a traditional punch card system whereby a user gets a loyalty card physically punched in order to mark a visit to a merchant. Once the user has received enough punches, as evidenced by the number of holes in his loyalty card, the user may redeem the card for a reward, such as for a free product or service. Various embodiments create an electronic embodiment of a punch card. Such a punch card may be stored and/or rendered on a user mobile device.

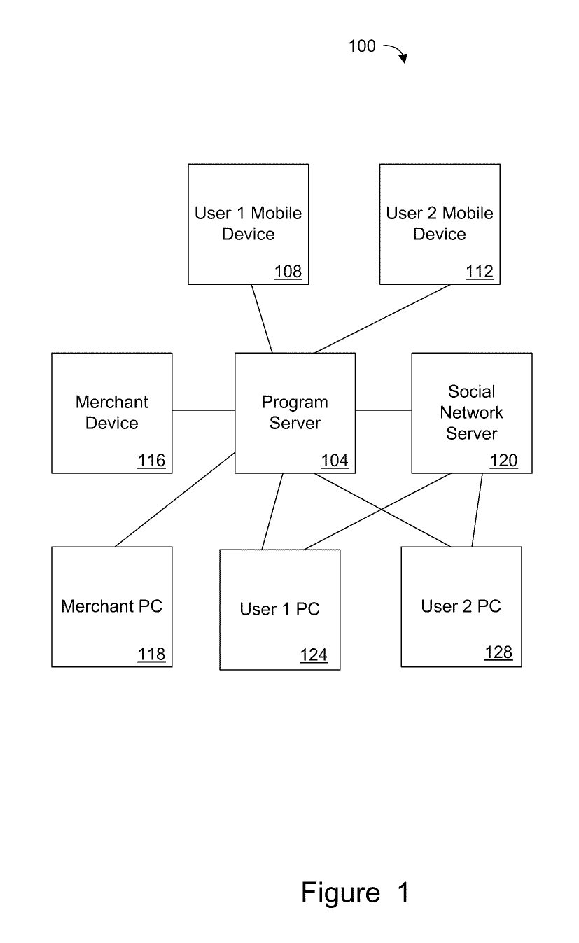

Referring to FIG. 1, a system is shown according to some embodiments. A system 100 may include a program server 104, which may be responsible for maintaining and operating a program for providing rewards to users in exchange for transacting with, and referring others to particular merchants. Program server 104 may be responsible for tracking users and merchants, authenticating transactions, enabling and tracking referrals, tracking the pursuit of rewards, and carrying out one or more additional functions according to various embodiments.

System 100 may include social network server 120, which may enable and/or maintain a social networking system, such as Facebook, MySpace, LinkedIn, etc. Program server 104 may be connected to social network server 120 via a network, such as via the Internet. Program server 104 may receive information from social network server 120, where such information may identify “friends” or other connections of a given user that participates in a program administered by the program server (e.g., a program to reward users for loyalty to certain merchants). The program server may, in turn, use this information to allow a user to indicate which of his connections he has referred to a given merchant, in some embodiments.

System 100 may include one or more user mobile devices, such as mobile devices 108 and 112. It will be appreciated that system 100 may include fewer or more mobile devices, and that system 100 is not limited in the number of mobile devices that may be included. A mobile device may include a cellular phone or smart phone, according to some embodiments. A mobile device may also include a personal digital assistant, laptop, portable computer, music player, mp3 player, pager, video game console, electronic reader, tablet computer, slate computer, global positioning system receiver, camera, digital camera, video camera, digital video camera, or any other electronic device, or any other suitable device.

In various embodiments, a mobile device may aid in the authentication of a transaction. For example, a user may employ a mobile device to photograph a transaction receipt in order to prove that the user was involved in the transaction. A mobile device may also allow a user to more readily track his progress towards obtaining a reward (e.g., by displaying an indication of progress to the user). A mobile device may also aid in the redemption of a reward (e.g., by storing a code that can be given to a merchant in order to redeem a reward).

A mobile device may be in communication with program server 104. As will be appreciated such communication may be direct, or it may be routed through a wireless network (e.g., cellular network), which in turn may be connected to the Internet. The mobile device may report and authenticate transactions to the program server 104. The program server 104 may transmit to the mobile device various information, such as codes that are redeemable for rewards, an indication of a user's progress towards a reward, information about a user's friends (e.g., so that the user may select a friend from a list in order to indicate who has referred the user to a given merchant), information about additional rewards that are available, or any other information.

System 100 may also include a merchant device 116. The merchant device may include a cash register or point of sale system. The merchant device may include a personal computer, computer, tablet computer, laptop, mobile device, or any other electronic device, or any other device. In various embodiments, the merchant device 116 may allow the merchant to provide transaction receipts, provide codes that can be used for authentication of a transaction by a user, track for the merchant the progress of one or more users towards a reward, track rewards being offered, indicate one or more benefits of an offered loyalty/rewards program (e.g., indicate how many new customer referrals have been received, e.g., indicate how many repeat customers have come as a result of the loyalty/rewards program), or perform any other function in conjunction with various embodiments.

Merchant device 116 may be in communication with program server 104. Merchant device may communicate information about new rewards being offered, information about criteria for making progress towards a reward (e.g. information about a minimum purchase amount that is required by a user), information about a transaction that has occurred, information about a redemption code that has been submitted by a user, and/or any other information. The merchant device may receive from the program server one or more redemption codes that may be validly submitted by a user (e.g., in order to redeem a reward from the merchant), an indication of one or more users' progress towards one or more rewards, an indication of the results or benefits of the rewards program (e.g., how many new users have been referred; e.g., how many additional transactions have taken place as a result of the rewards program), and any other information.

Whereas FIG. 1 illustrates one merchant device, it will be appreciated that more or fewer such devices may be present, in various embodiments. It will be appreciated that various embodiments do not place a limit on the number of merchant devices.

System 100 may include a merchant personal computer 118. A merchant may use the personal computer 118 to, for example, log into an account with the program server 104. In various embodiments, as will be appreciated, the merchant may use any suitable device, and need not be limited to the use of a personal computer. For example, the merchant may utilize a laptop, mobile device, or any other electronic device, or any other device. Using merchant computer 118, the merchant may add new reward offerings, update reward criteria, view an indication of transactions at the merchant, view graphical renditions of data (e.g., view charts of transactions over time; e.g., view charts of new referred users over time; e.g., view charts of rewards given over time, etc.), and so on.

System 100 may include a user personal computer. A user may use the personal computer 118 to, for example, log into an account with the program server 104. In various embodiments, as will be appreciated, the user may use any suitable device, and need not be limited to the use of a personal computer. In some embodiments, the user may use his account to view progress towards rewards, research other rewards that are available, research other merchants that are available, see recommendations of merchants by others, see recommendations by “friends” other social connections, and so on.

In various embodiments, a user may use the personal computer to log into the social network server 120. There, the user may perform any number of functions related to social networking, in various embodiments. For example, the user may submit photographs, videos, information recounting life events, or any other information. The user may view his, view the profile of a connection, view the profile of another, send a message to another user, read a message from another user, or perform any other function.

Whereas FIG. 1 illustrates one merchant PC and two user PCs, it will be appreciated that more or fewer such devices may be present, in various embodiments. It will be appreciated that various embodiments do not place a limit on the number of merchant PCs or the number of user PCs.

As will be appreciated, when two or more devices are in communication, such communication may be continuous, periodic (e.g., every minute; e.g., every hour; e.g., every day), sporadic, ad-hoc, as needed, intermittent, or may occur with some other frequency.

As will be appreciated, two or more devices may be connected or in communication via various transmissions media and/or combinations of transmission media. Transmission media may include wired or wireless means of signal transmission. Transmission media may include cable, copper wire, copper cable, coaxial cable, Ethernet, fiber, fiber optics, power lines, air, water, and any other suitable transmission media.

As will be appreciated, two or more devices may be in communication via a number of means and/or protocols, and/or by a combination of such. These may include wired, wireless, Bluetooth, Wi-Fi, laser, microwave, infrared, optical, cellular, PCS, transmission control protocol (TCP), internet protocol (IP), TCP/IP, RFID, NFC, and so on.

As will be appreciated, two or more devices may be in communication via a number of intermediate stages or devices. For example, two devices may be in communication via one or more switches and routers.

In various embodiments, communication between devices may be near instantaneous. In various embodiments, there may be a lag in communications. In various embodiments, communication may be synchronous or asynchronous.

As will be appreciated, “devices” or other objects as described herein need not be embodied as singular or monolithic devices. In various embodiments, a given device may, in fact, be embodied as multiple physically separate components or component devices. For example, a server according to various embodiments may comprise multiple physically separate hardware servers, or hardware components. In various embodiments, two or more “devices” or objects as described herein may be embodied as a single, combined device or object.

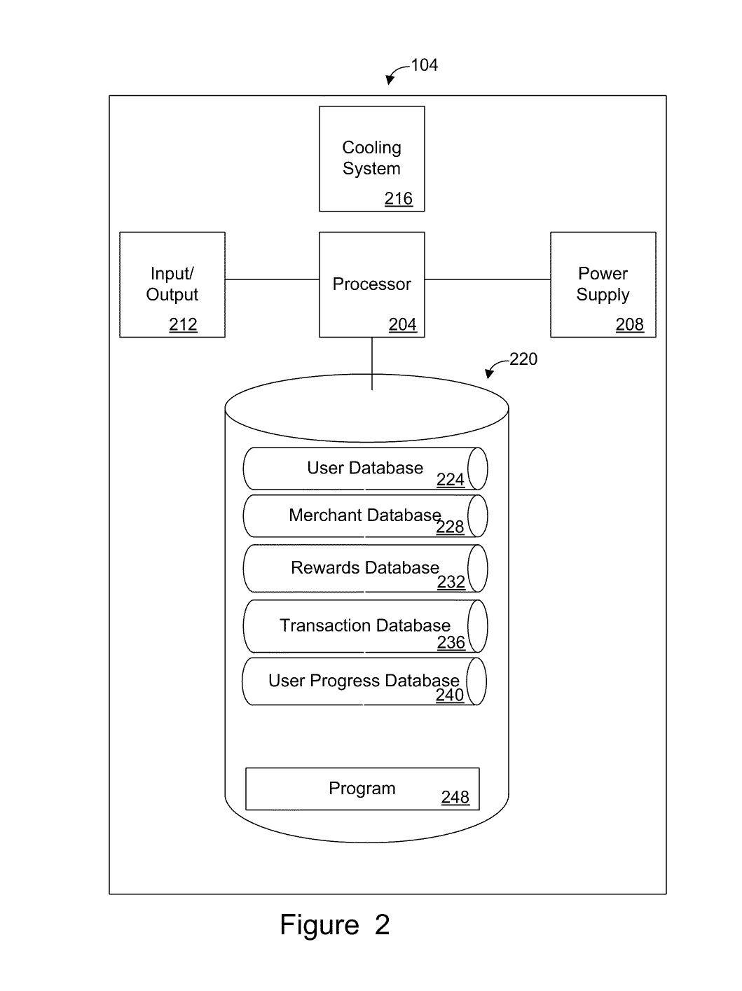

FIG. 2 illustrates a program server 104 according to some embodiments. The program server may comprise a single hardware unit, multiple hardware units (e.g., multiple individual servers; e.g., separate processors and data storage; etc.), or even a virtual server. The server may comprise a cloud server, which may draw on the resources of a plurality of separate physical hardware components or devices.

As depicted, program server 104 includes a processor 204, which may be an Intel, ARM, AMD, or other processor, or set of processors. Processor 204 may be a graphics processing unit, in some embodiments. Power supply 208 may include connections to an electrical grid, power stabilizers, generators, batteries, or any other source of power. Input/output 212 may include a communication interface to a network, such as a local area network, wide-area network, private network, public network, Internet, wired network, wireless network, etc. Via input/output 212, program server 104 may communicate with other devices in system 100, according to various embodiments. Cooling system 216 may comprise air conditioners, fans, or any other means for effecting climate control. Program server 104 may include memory 220, which may store data used in various embodiments.

Memory 220 may also include a program 248, or multiple programs. Program 248 may include an operating system, one or more applications, and any other items of software or computer code that may be used in accordance with various embodiments. In operation, processor 204 may execute instructions of program 248, and may utilize data stored within memory 220. Processor 204 may also direct the transmission of commands or data via input/output 212, and may also operate on any data received via input/output 212.

It will be appreciated that FIG. 2 and other figures depict illustrative embodiments, but that other forms, configurations, quantities of components, arrangements of components, divisions of components, and so on are also contemplated.

Memory 220 may organize stored data into various databases. However, it will be appreciated that there are many other possible ways of storing and arranging data, and that such ways are also contemplated in various embodiments. Databases may include a user database 220 for storing information about users participating in a rewards or loyalty program administered by program server, according to some embodiments. Merchant database 228 may track merchants that participate in the rewards program, e.g., by offering products in exchange for a certain amount of business or a certain amount of referrals from users. Rewards database 232 may track rewards offered by merchants. Transaction database 236 may track transactions that have been consummated between a user and merchant. A record of such transactions may allow program server 104 to ascertain when a user is entitled to a reward. The transaction record may also allow the merchant to keep a record of additional business it may have obtained as a result of its participation in the program administrated by the program server 104. User progress database 240 may allow the program server 104 to track a user's progress towards earning a reward from a merchant.

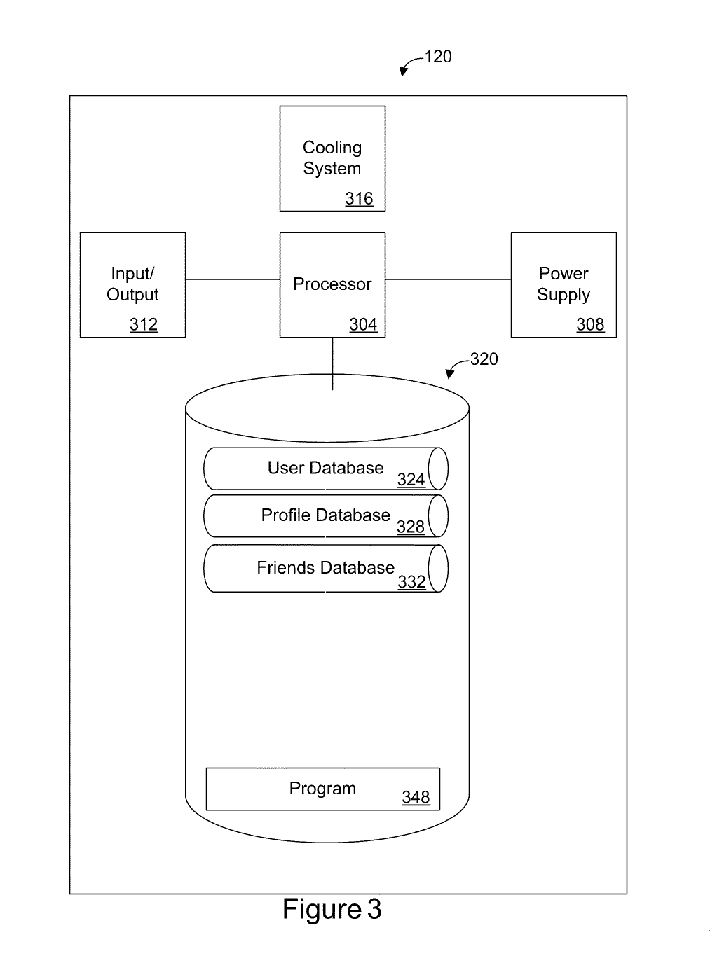

Referring to FIG. 3, a social network server 120 is illustrated according to some embodiments. The social network server may comprise one or more hardware components as previously described. The social network server may or may not explicitly cooperate with the program server 104. In some embodiments, the social network server operates or enables a distinct business or application. In some embodiments, the social network server operates or enables an unrelated business or application from that of the program server. The program server 104 may obtain information from the social network server in various fashions, such as through an application programming interface.

The social network server 120 may store information about its users. Such information may be stored in database 324. Users of the social network server may be distinct from user of the program server, although there may be overlap. In various embodiments, one or more users of the program server 104 are also users of the social network server 120.

A profile database may 328 may store information about one or more users of the social network server. Such information may include biographical information, preference information, pictures, portraits, videos, favored links, and so on.

A “friends” database 332 may store indications of the social connections that a user has made. Such connections may constitute mutual agreement by a first and second user to become connected. It will be appreciated that a social connection may have various levels of significance, and may be accomplished in various ways. For example, when two users are connected (e.g., become friends), then the two users may have the abilities to send messages to one another or to see more profile information of one another.

In some embodiments, the program server 104 may poll the social network server 120 for an indication of who are the friends of a given user. For example, the program server may wish to allow a user to select which of his friends has referred him to a given merchant.

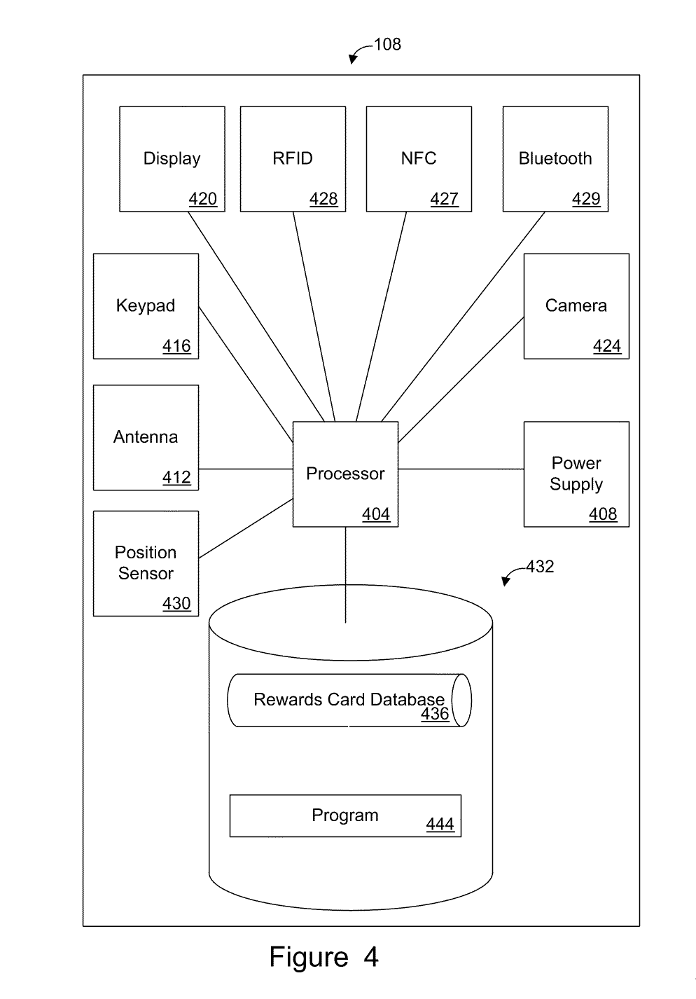

Referring to FIG. 4 a user mobile device 108 is depicted according to some embodiments. The mobile device may be any variety or brand of mobile device, and may include, for example, an Apple iPhone, a Blackberry Curve, HTC Evo, Samsung Galaxy, etc. Processor 404 may be any suitable processor, such as a processor capable of executing computer instructions. Antenna 412 may allow the phone to wirelessly communicate with a cellular base station, another cell phone, or another device using electromagnetic signals. Keypad 416 may include one or more user input buttons which may convert user mechanical inputs into electronic signals for the processor. The keypad may include a numeric keypad, alphanumeric keypad, QWERTY keypad, or any other set of keys. Display 420 may include a liquid crystal display, electronic ink display, light emitting diode display, organic light emitting diode display, or any other display. Display 420 may include touch sensing capabilities. Thus, in some embodiments, display 420 may be capable of both output signals to a user, and receiving inputs from a user.

Radio frequency identification (RFID) 428 may include an RFID reader and/or an RFID tag. RFID 428 may allow mobile device 108 to send and/or receive short range electric signals wirelessly. In some embodiments, RFID 428 may enable mobile device 108 to transmit a unique identifying signal. Using such a signal, for example, a merchant device may uniquely identify a user's mobile device, and may therefore authenticate that a transaction has taken place with that user. In some embodiments, a user mobile device may receive an RFID signal from a merchant device, and transmit information from that signal to the program server 104. This may also serve to authenticate a transaction in which a user has engaged with a merchant.

In various embodiments, mobile device 108 may include additional or alternative means of short-range electronic communication. In various embodiments, mobile device 108 may include NFC 427 and/or Bluetooth 429. In various embodiments, mobile device 108 may include additional or alternative means of electronic communication.

Camera 424 may allow mobile device 108 to capture photographs. Such photographs may be stored in memory 432, or may be transmitted to another device (e.g., to program server 104). Such photographs may be used to report a transaction. Such photographs may be used to authenticate a transaction. For example, a transaction receipt may contain a unique code (e.g., a bar code, e.g., a QR code) that may be interpreted by mobile device 108 (or by program server 104), and may be unequivocally tied to the transaction.

Position sensor 430 may include a global positioning system receiver, a receiver capable of triangulating data from cellular phone towers, or any other position sensor. The position sensor may be used to ascertain the location of the mobile device at the time of a transaction. If the location of the mobile device matches the known location of a merchant with which the transaction is reported, then the transaction may be deemed valid, or at least more likely to be valid, in various embodiments.

Memory 432 may be used to store various data, and to store a program 444. Program 444 may include computer code that, when executed, may allow processor 404 to operate in accordance with various embodiments. In various embodiments, the computer code may be downloaded as an application, e.g., from the program server 104.

Rewards card database 436 may store in indication of one or more rewards the user is pursuing. The database may serve as a virtual or electronic punch card, and may track how many times a user has visited a merchant, how many times a first user has referred a second user to a merchant, what a reward is, and any other pertinent information. Rewards card database 436 may also store a code or other item of information that may allow a user to redeem a reward once the user has earned it.

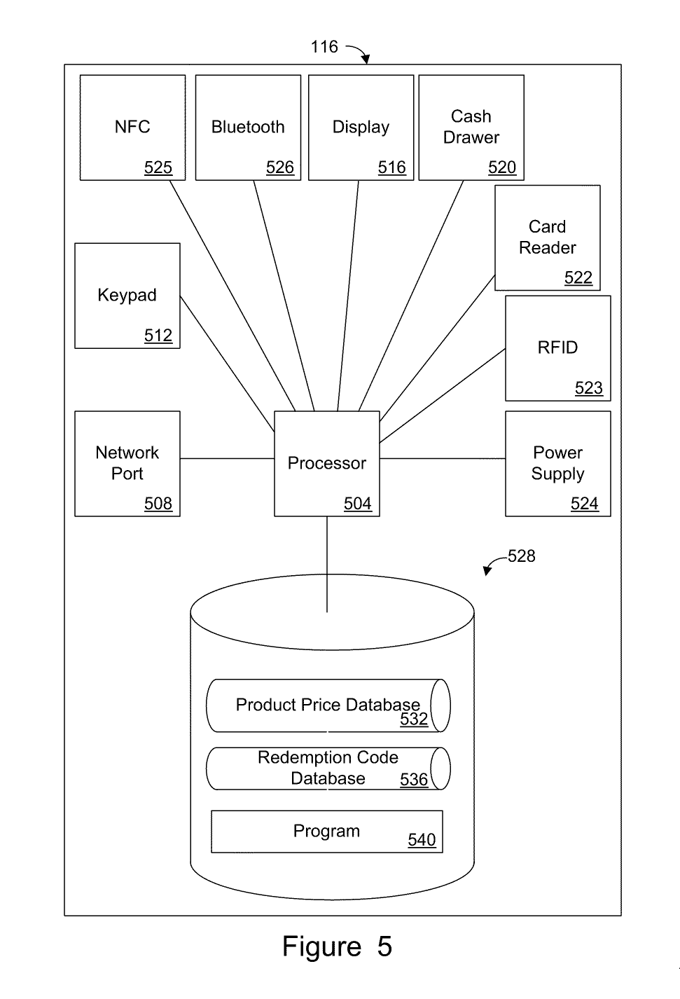

Referring to FIG. 5, a merchant device 116 is illustrated according to some embodiments. The merchant device may have cash handling abilities (e.g., cash drawer 520, card reader 522). The card reader may allow the merchant device to receive credit cards, debit cards, or other types of cards linked to financial accounts. The merchant device may have characteristics of a general purpose computer (e.g., processor 504, network port 508, power supply 524, memory 528). RFID 523 may include an RFID reader and/or an RFID tag. RFID 523 may allow the merchant device to communicate with a user mobile device, as previously described. In various embodiments, merchant device 108 may include NFC 525 and/or Bluetooth 526, which may also or alternatively allow a merchant device to communicate with a mobile device.

Stored in memory 528 may be various data that may allow the merchant to effectively manage its business. Such data may also include data for participating in, and/or interacting with a loyalty/rewards program administered by program server 104.

Product price database 532 may allow the merchant to keep track of prices for one or more products or services. This may allow efficient billing of users for a transaction. This may also allow for ready determination as to whether a user has met a criterion for progressing towards a reward (e.g., for receiving a punch). For example, in some embodiments, a user must purchase products of a certain minimum price in order to advance towards a goal. Such price may be ascertained from price database 532.

Redemption code database 536 may store codes that are redeemable by users for rewards. In some embodiments, a user must present to the merchant a code that matches a code in the redemption code database in order to receive a reward. If there is a match, then presumably the user has received the code from the program server 104, which has also provided the same code to the merchant. The codes may be long enough or unique enough (e.g., contain enough digits) that it will be unlikely a user could make up a code on his own that would match a code in the redemption code database.

In various embodiments, once a user submits a valid redemption code, then that redemption code is eliminated from the redemption code database 536 so that it can no longer be used for the same reward.

Program 540 may store computer code that, when executed, may cause processor 504 to operate in accordance with various embodiments. In various embodiments, the computer code may be downloaded as an application, e.g., from the program server 104, or from a website featuring applications for mobile devices.

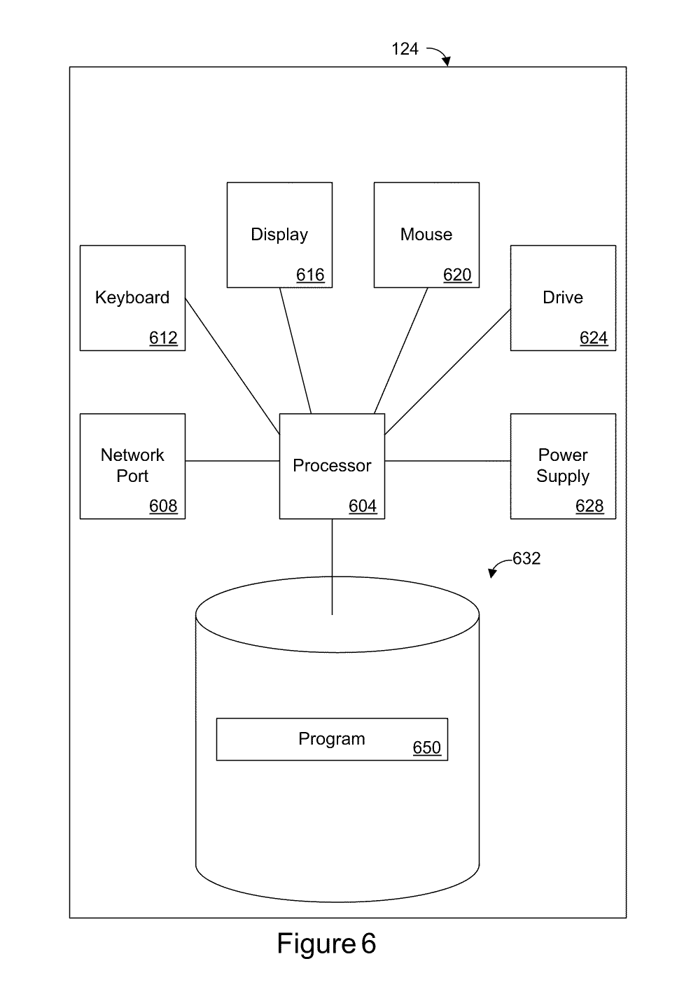

FIG. 6 illustrates a user personal computer 124 according to some embodiments. As will be appreciated, personal computer 124 may be used by a user to view and/or manage information about his participation in loyalty/rewards program administered by the program server 104.

Through the personal computer 124, a user may log into a website of the program server 104. In various embodiments, the user may also utilize personal computer 124 to access social network server 120. Through an account at the social network server 120, the user may post information to his profile, create social connections with other user, send messages, and so on.

As will be appreciated, a merchant may similarly utilize a personal computer, or any other device, to view and/or manage information about his participation in loyalty/rewards program administered by the program server 104.

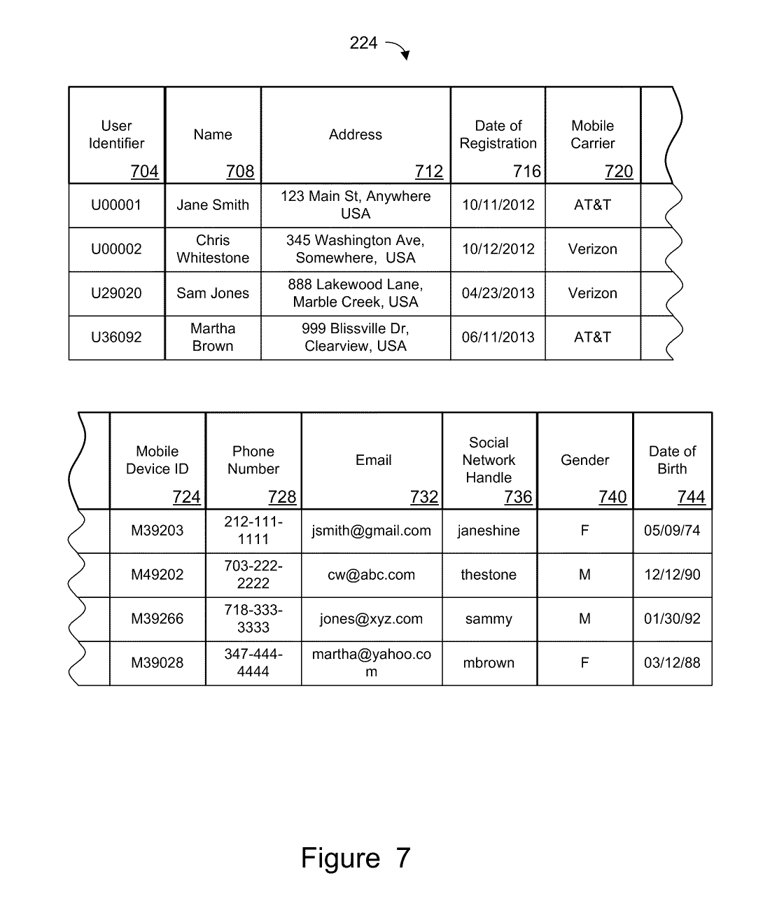

Referring to FIG. 7, a user database 224 is illustrated according to some embodiments. The user database may store information about a user that can be utilized in the administration of a program according to various embodiments. In various embodiments, information stored about a user may be used for authentication purposes. For example, by storing a user's home address, transactions that occur far away from such address over a consistent period of time may be viewed with suspicion.

In various embodiments, the user database may include a social network handle 736, which may include an assumed name or identity that that the user employs within a social network. By reference the handle, the program serve 104 may poll the social network server 120 for the social connections of the user.

Various information about the user may also be used to make recommendations to the user. For example, recommendations of merchants or rewards may be transmitted to a user based on the user's gender or date of birth (i.e., age).

As will be appreciated, the data illustrated in FIG. 7 and in other figures represents exemplary data. As will be appreciated, the databases illustrated in FIG. 7 and in other figures represent but some arrangements of data, and that other arrangements are possible and are also contemplated. For example, databases or database tables may have more or fewer fields, and may have more or fewer row entries. Additionally, data need not be stored in the form of databases or database tables, but may be stored in any suitable fashion. In some embodiments, data or related data need not all be stored in the same place, but may be broken up across multiple memory locations, multiple hardware components, multiple devices, multiple locations, and so on.

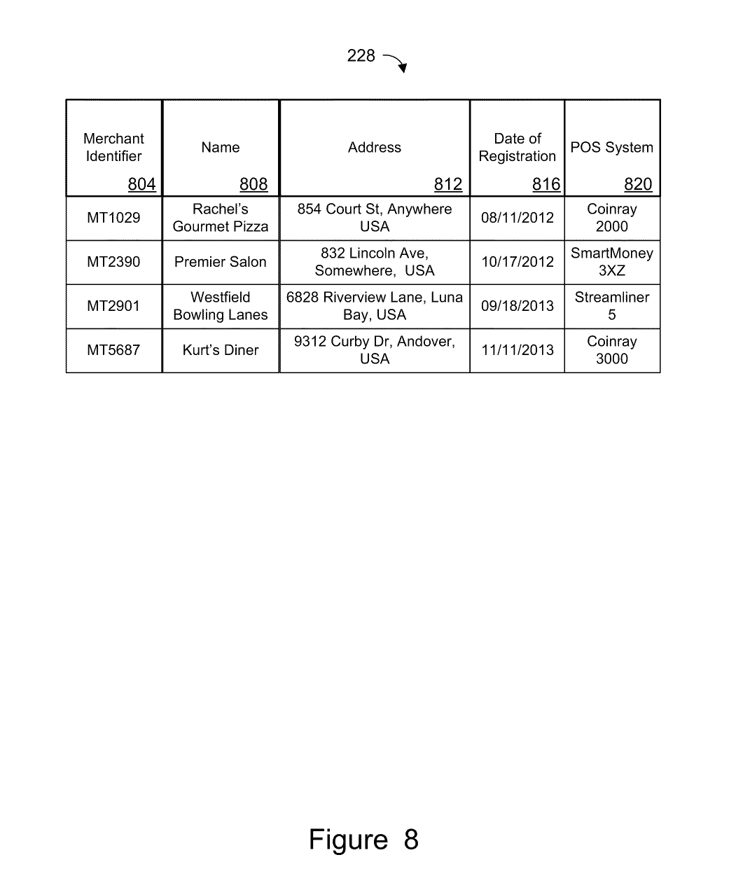

Referring to FIG. 8, a merchant database 228 is illustrated according to some embodiments. The merchant database may store information about merchants participating in a loyalty/rewards program administered by program server 104. Information stored may include a merchant's name (field 808), place of business (field 812), date of registration with the program (field 816), and type of point-of-sale (POS) system utilized (field 820).

In some embodiments, address information about a merchant may aid in the authentication of transactions. For example, a user mobile device may report the location of a transaction via position sensor 430. The location data reported by the user mobile device may be compared with the address of the merchant at which the transaction supposedly took place in order to see if the two correspond.

POS system field 820 may, in some embodiments, aid the program server 104 in determining the format of data or the type of data that should be transmitted to the merchant, and/or the type of data that can be expected from the merchant. In some embodiments, different POS systems may have differing capabilities when it comes to authenticating transactions. For example, certain POS systems may have RFID tags or sensors, whereas others may not. For those that do have RFID sensors or tags, an extra layer of authentication for a transaction may be feasible. In some embodiments, the program server 104 may send different format redemption codes depending on the nature of the POS system.

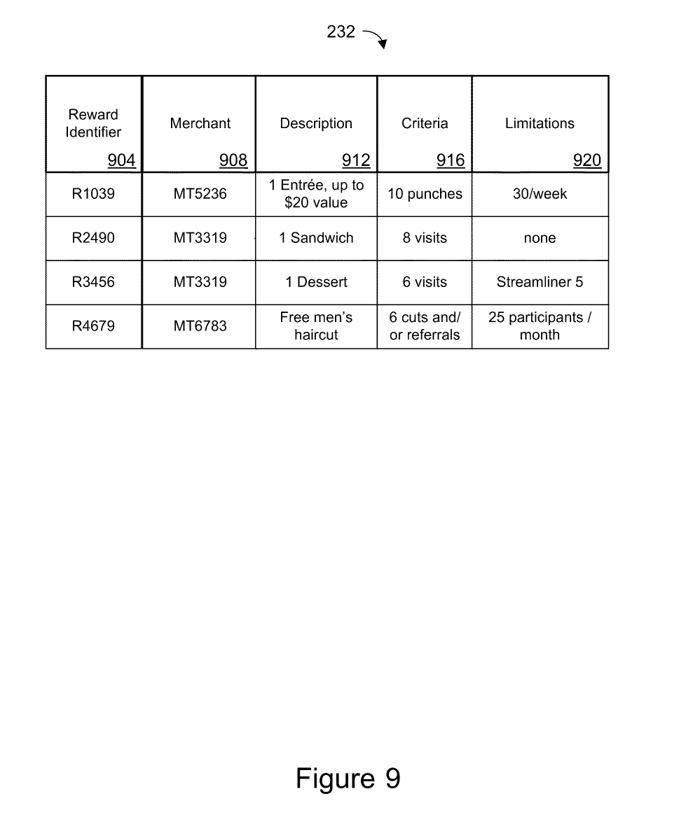

Referring to FIG. 9, a rewards database is shown according to some embodiments. The rewards database may allow program server 104 to track rewards that are available to users. Merchant field 908 may identify the merchant offering a particular reward. Description field 912 may provide a description of a reward. The description may include various levels of detail, in various embodiments. In some embodiments, a description field may indicate a general category of a reward. In some embodiments, a description may indicate a specific product or service being offered.

Criteria field 916 may indicate one or more criteria that are required of a user in order to earn a reward. A criterion or criteria may take the form of a number of “punches” required. A punch may correspond to a unit or increment of progress towards earning a reward. A punch may represent or signify receiving a hole punched in a punch card or tracking card. The punch card may be virtual or electronic, and thus a punch may represent a virtual or electronic hole, or depiction of such hole. In any event, a certain number of punches may be required in order for a user to receive a reward.

Though not shown, database 232 or some other database may include one or more additional fields storing criteria for earning a punch.

In various embodiments, a merchant may wish to have one or more limitations on the number of rewards that will be offered. For example, as a merchant may be giving out free products or services, the merchant may wish to limit the potential number of products or services it gives away so as to limit any potential loss. In various embodiments, a merchant may limit the number of rewards that can be redeemed in any given period of time (e.g., the number per week), the number of people that may be eligible to progress towards an award (e.g., only 100 people can progress towards a given reward at one time), the number of times a given person may earn a reward, and any other limitation. In some embodiments, a merchant offering a reward may be limited in the ways in which a transaction can be authenticated. For example, a merchant may utilize a particular type of POS system which may have only limited capabilities for authentication. In such cases, there may be restrictions on what users can participate, for example. For instance, only users with mobile devices capable of interacting with the merchant's POS system may participate. As will be appreciated, various other limitations are possible and are contemplated.

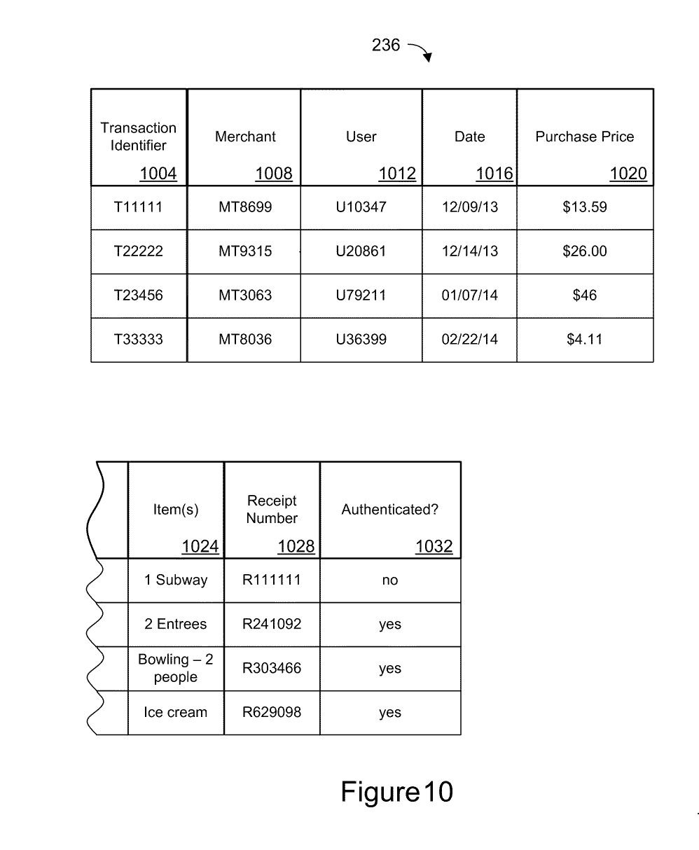

Referring to FIG. 10, a transaction database 236 is illustrated according to some embodiments. The transaction database may allow the program server 104 to track a user's progress towards achieving a reward, to measure the impact (e.g., positive impact) of participation by a merchant on the merchant's sales, to find patterns in behavior useful for transaction authentication, and to server any other purpose. The transaction database may track, for example, the date (field 1016) of a transaction, the user (field 1012) and the merchant (field 1008) involved, and the purchase price (field 1020). As will be appreciated, in various embodiments, other aspects of a transaction may be tracked. For example, tracked items may include a time of purchase, an item purchased, a number of people in the user's party, a mode of payment, a mode of authentication, a geographic location of the transaction, whether the transaction involved redemption of a reward, and/or any other aspect of a transaction.

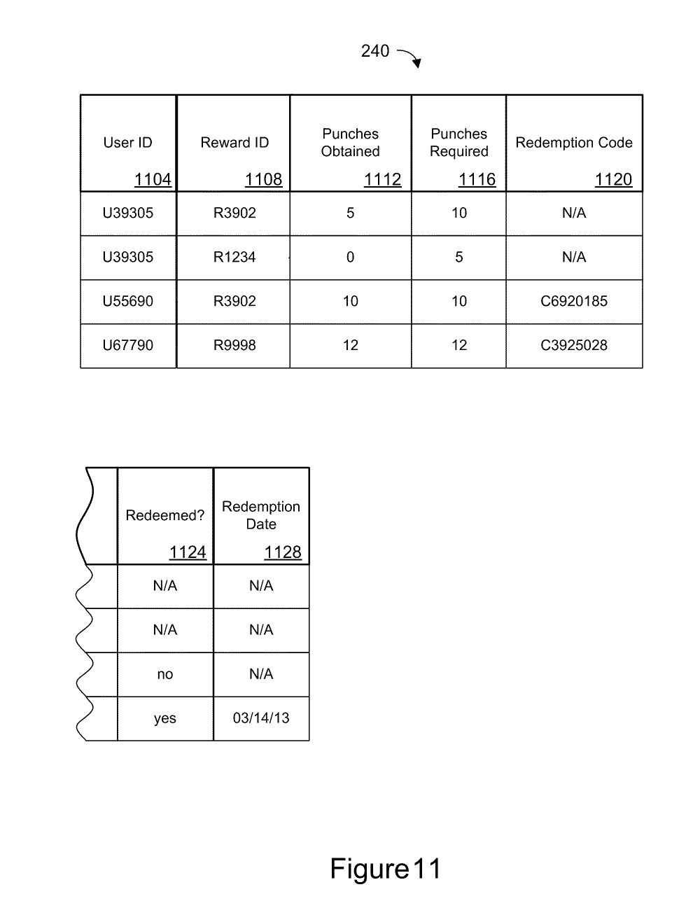

Referring to FIG. 11, a user progress database 240 is illustrated according to some embodiments. User progress database 240 may allow program server 104 to track a user's progress towards receiving a reward. It may also server to track redemption codes (field 1120) that may be used by a user in redeeming a reward. When a user submits a redemption code to the program server 104 (e.g., by first giving the code to a merchant, after which the merchant submits the code to the program server), the program server may verify that the submitted redemption code matches the code associated with the user. In some embodiments, the database 240 may track whether or not a redemption code has been redeemed (field 1124), and may thereby prevent its future, repeated redemption. In some embodiments, database 240 may serve to consolidate information found in transaction database 236.

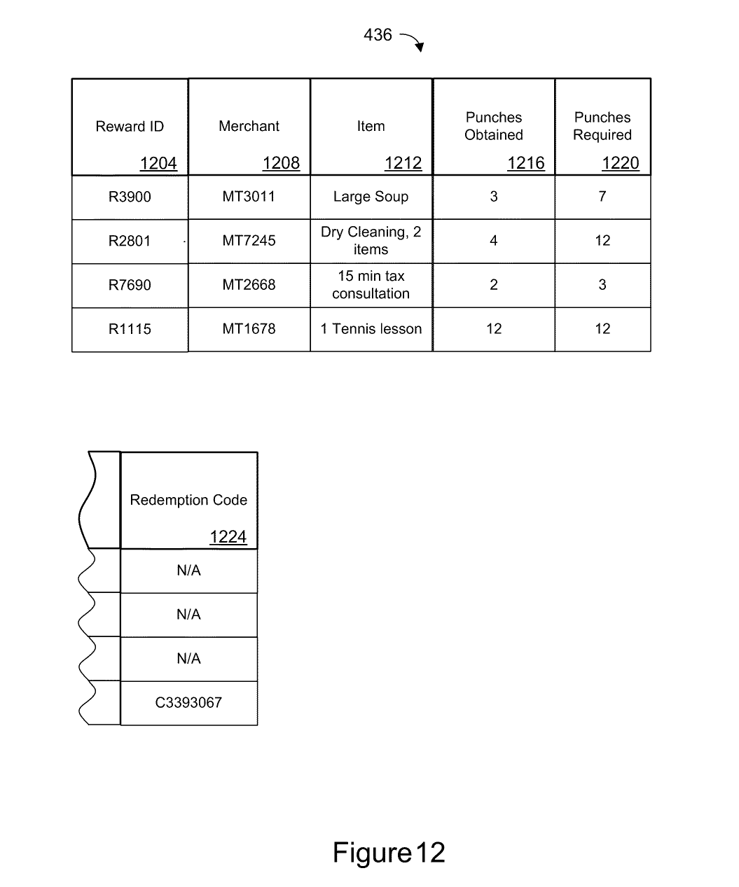

Referring to FIG. 12, a rewards card database 436 is shown according to some embodiments. The rewards card database 436 may be stored locally on a user's mobile device. The database may thus give the user ready access to information about his progress towards a reward. In other words, in some embodiments, the rewards card database may represent the equivalent of one or more punch cards being stored electronically in the user's mobile device.

In various embodiments, in order to display to the user information stored in the rewards card database 436, the user's mobile device may depict a graphical rendering of a rewards card or punch card. The card may show a number of holes punched in it, where the number of holes correspond to the “punches obtained” field 1216.

In various embodiments, the rewards card database 436 may be periodically updated. The updates may come by way of the program server 104 communicating to the mobile device. Such a communication may indicate that a transaction in which the user has engaged has been successfully reported. In various embodiments the rewards card database 436 may be updated by the user mobile device itself, e.g., after the user has photographed a receipt and the mobile device has determined that the receipt merits a further increment of progress towards earning the reward.

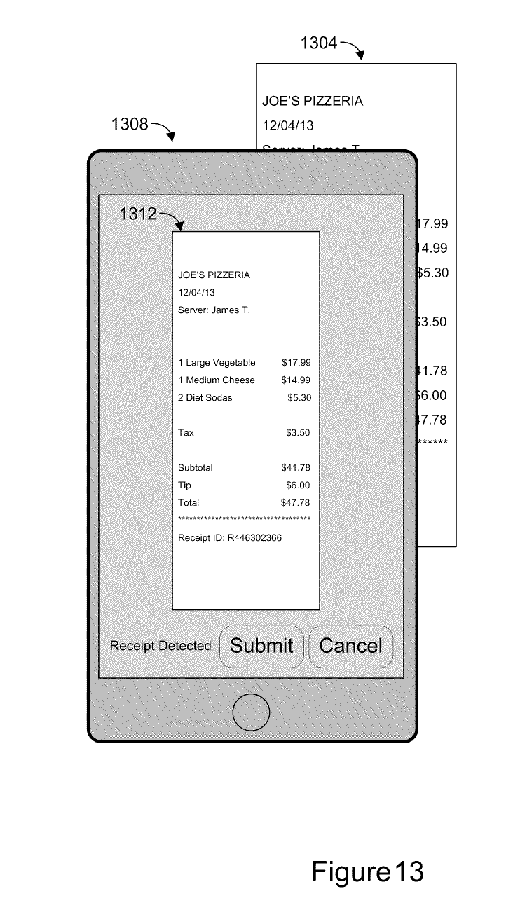

Referring to FIG. 13, a means for authenticating a transaction is illustrated according to some embodiments. In the figure, a user may have recently engaged in a transaction (e.g., the purchase of a pizza meal at “Joe's Pizzeria”), and may have been presented with a receipt 1304 for the transaction. The user may then point the camera of his mobile device 1308 towards the receipt, resulting in an image of the receipt 1312 appearing on the display screen of the mobile device. In various embodiments, software residing with the mobile device may perform image or character recognition algorithms on the receipt, and may ascertain that the camera of the mobile device is indeed pointing to a receipt. The mobile device may then present the user with an opportunity to “submit” the receipt for the purposes of reporting and/or authenticating the transaction between the user and Joe's Pizzeria. If the user chooses to submit, then the image of the receipt may be captured. The mobile device may then ascertain information from the receipt, such as ascertaining the receipt ID using optical character recognition. In some embodiments, the mobile device may transmit ascertained information, or the image itself to the program server 104. If the mobile device transmits the entire image, then the program server may itself interpret the image (e.g., ascertain or derive information from the image).

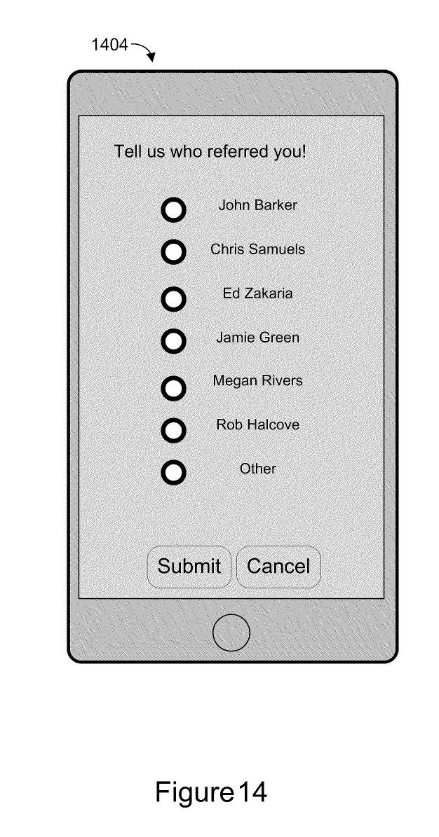

Referring to FIG. 14, a means for reporting a referral is illustrated, according to some embodiments. The figure depicts a user's mobile device asking the user to select from among a list of people who may have referred the user to a particular merchant (e.g., to Joe's Pizzeria). The list may consist of social connections of the user. This list, in turn, may have been derived by the program server 104 by polling the social network server 120. The user may have the opportunity to select one of the people from the list (e.g., by touching the corresponding check box to the left of the appropriate name). The user may also have the opportunity to check “other”, and then, for example, may key in the name of another user who has referred the user.

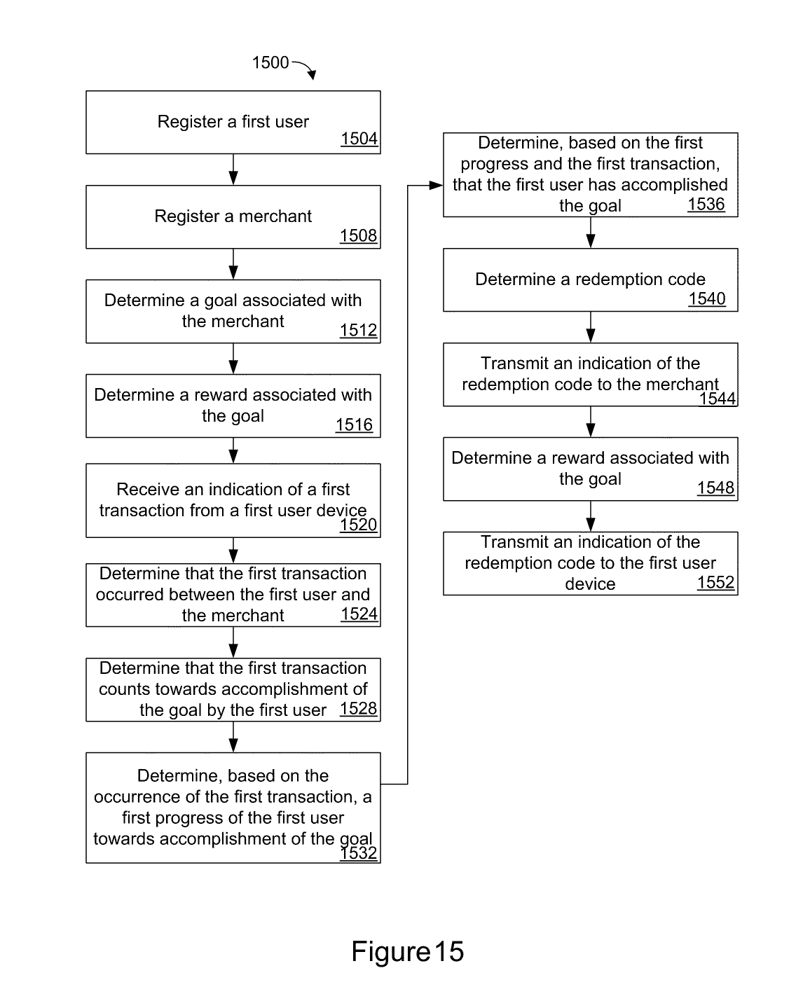

Referring to FIG. 15, a process flow 1500 is shown according to some embodiments. The steps in the process flow may be performed by the program server, according to some embodiments.

As will be appreciated, the steps in the process flow may be performed in a different sequence than that depicted, according to some embodiments. As will be appreciated, in various embodiments, more or fewer steps may be performed in the process flow.

At step 1504, the program server may register a user. A user may register through a website of the program server. The user may provide various user information, including name, address, age, etc., which may in turn be stored in a database such as user database 224. The user may register using user mobile device 108, user PC 124, or via any other device, or in any other fashion. Upon registration, a user may provide information about one or more social networks to which the user belongs. The program server may later use information from these social networks to determine which of the user's friends the user has referred to a merchant. In various embodiments, upon registration, a user may provide information about the user's mobile device, including, for example, a phone number. The server may later communicate with the mobile device and may associate the mobile device with the user.

In some embodiments, upon registration, or at any other time, a user may download an application onto his mobile device. The application may comprise computer code that may allow the mobile device to function in accordance with various embodiments. Such application may support the tracking of user transactions, communication with the program server, the rendering of information about a user's progress, and any other data or processes.

In various embodiments, a user may provide one or more items of information to the server at a time other than a time of registration. In some embodiments, a user may provide information without explicitly registering. In some embodiments, the program server may track a user without having explicitly registered the user.

At step 1508, the program server may register a merchant. A merchant may sign up in order to improve the sales and/or marketing of its products or services. For example, the merchant may wish to encourage people to visit more frequently by offering people the possibility of receiving a reward after a certain number of visits.

Upon registration, or at any other time, a merchant may provide information about itself. Information may include name, address, products or services offered, and so on. Such information may be stored in a database, such as in merchant database 228.

At step 1512, the program server may determine a goal associated with the merchant. The goal may be a goal that a user must accomplish in order to receive an award. The goal may require a certain number of visits to the merchant, a certain number of transactions with the merchant, a certain total purchase from the merchant, a certain number of referrals of others to the merchant, and/or any combination of the foregoing. In some embodiments, a goal may require a user to promote the merchant in some way, such as by wearing a t-shirt with the merchant's logo for a certain number of days. As will be appreciated, a goal may take any other form. In some embodiments, a goal may take the form of a certain number of required punches of a virtual punch card or loyalty card.

At step 1516, the program server may determine a reward associated with the goal. This may be a reward that a user will earn upon achievement of the goal. A reward may be a particular product or service offered by the merchant. For example, the reward might be a food item, a haircut, a manicure, an eye exam, a bowling session, a movie viewing, a smoothie, or any other product or service. A reward may include a free product or service. A reward may include a discounted product or service. A reward may include a general discount off any of a number of merchant products or services. A reward may include a gift card to the merchant.

In some embodiments, a reward is not related to a merchant's product or service. For example, a reward may be a cash reward provided by the merchant, a concert ticket provided by the merchant, and so on.

In some embodiments, a merchant may determine a reward it will offer and communicate this reward to the program server. In some embodiments, the program server may suggest a reward to be offered by the merchant. For example, the program server may suggest a reward based on those that have been offered by other merchants in a similar line of business, and/or based on the success of other rewards that have been offered by other businesses. In some embodiments, the program server may determine a reward on its own.

In some embodiments, the program server 104 may verify one or more items of information about the merchant. The program server may verify the existence of the merchant, the address of the merchant, the nature of products or services offered, the quality of products or services offered, the reputation of the merchant, or any other aspect of the merchant. The program server may wish to maintain a reputable system that is attractive to user participants, and so may wish to avoid situations where participants become dissatisfied with a reward or with a merchant itself. The program server may verify information in various ways, such as by dispatching a representative to visit the merchant, by verifying newspaper reviews of the merchant, or in any other fashion.

It may come to pass that a registered user and a registered merchant engage in a transaction. For example, the user may eat at the restaurant of the merchant. For example, the user may buy stationary from the merchant.

As step 1520, the program server 104 may receive an indication of a first transaction from a first user device. In some embodiments, the user may use his mobile device (e.g., user mobile device 108) to report on his transaction with the merchant.

In some embodiments, a user may key in one or more details of his transaction into an application on his mobile device. For example, the user may key in the merchant's name, a product purchased, a purchase price, and so on. In some embodiments a user device may automatically ascertain one or more items of information about a transaction. For example, the mobile device may utilize an embedded position sensor to determine the location of the merchant. Such location may then be correlated with the identity of the merchant. In some embodiments, the mobile device may ascertain information from a local wireless network, such as from a wireless network administrated by the merchant. The merchant may communicate information about itself and/or about the transaction to the mobile device via the wireless network. The wireless network may include Bluetooth, Wi-Fi, or any other means of wireless networking or wireless communication. In some embodiments, the mobile device may ascertain information via communication or wireless communication with a merchant device, such as a point of sale system. Communication may occur via RFID technology. For example, the mobile device may detect an RFID tag on a merchant device, where such tag may server to identify the merchant.

In some embodiments, a mobile device may photograph or otherwise scan a receipt. The mobile device may use character recognition to ascertain information about a transaction, such as date, items purchased, purchase price, merchant id, and so on. In some embodiments, the receipt may contain a barcode or QR code that provides information about the transaction. In some embodiments, the receipt may include some other image, logo, design, code, etc., which may convey to the mobile device information about the transaction.

In some embodiments, a mobile device may interpret a scanned or photographed receipt, and may itself derive information about a transaction. In some embodiments, the mobile device may transmit a scanned image or photograph to the program server, which may itself derive information from the scan or photograph.

In some embodiments, a receipt may be submitted by a device other than a user mobile device. In some embodiments, a receipt may be submitted via feature phones, via web browser, via email using a desktop computer, or via any other device, or via any other program.

In some embodiments, information received about a transaction may be stored in a database such as in transaction database 236.

It will be appreciated that various embodiments contemplate an interaction between a user and a merchant that need not be classified as a transaction. For example, the interaction need not involve a payment or an exchange of items of tangible value. In some embodiments, a user may simply visit a merchant, answer a survey about a merchant, sample a merchant's product, take a brochure from the merchant, provide contact information to the merchant, or otherwise interact with the merchant. In various embodiments, a user may be eligible to progress towards a goal and to earn rewards based on such interactions.

At step 1524, the program server may determine that the first transaction occurred between the first user and the merchant. For example, the program server may infer that the user was involved if the program server has received a report of the transaction from the user's mobile device. The user's mobile device may, in turn, be associated with the user (e.g., via user database 224). The program server may receive information about the merchant from the user's mobile device, such as the merchant's identity. The program server may determine or ascertain information about the merchant from the scan of a receipt received from the user's mobile device.

In various embodiments, the program server 104 may take one or more measures to authenticate the transaction. For instance, the program server may take steps to verify that the transaction actually took place, that the transaction was actually for the products or services reported, that the transaction was actually between the user and the merchant reported, that the transaction was for the amount reported, that the transaction was on the date reported, and so on. By authenticating the transaction, the program server may help ensure the integrity of the loyalty/rewards program, and may help to ensure that merchants truly are gaining valuable business in exchange for the rewards they are giving away.

### Alpha-Numeric Code

According to some embodiments, a unique alpha-numeric code is known by employees of the merchant, and entered on a user's mobile phone after the purchase. This code is validated and used to confirm the purchase. This code can be changed by the merchant. There can be one code for the entire merchant, or a unique code for each employee or worker at the location.

In various embodiments, the code is initially generated by the merchant and also submitted to the program server 104. In some embodiments, the code is initially generated by the program server 104 and then given to the merchant.

### Radio Frequency Identification

According to some embodiments, a unique RFID tag is presented to the user after they complete a purchase. The user's mobile phone reads the RFID tag, and sends a unique key which validates the purchase. For example, the user's mobile phone may send the unique key to the program server 104, which may already have the key on record or may otherwise have the ability to associate the key with the merchant.

### Near Field Communication (NFC)

According to some embodiments, a unique NFC tag is presented to the user after they complete a purchase. The user's mobile phone reads the NFC tag, and sends a unique key which validates the purchase. For example, the user's mobile phone may send the unique key to the program server 104, which may already have the key on record or may otherwise have the ability to associate the key with the merchant.

### Quick Response Code (QR Code)

According to some embodiments, a unique QR code is presented to the user after a purchase. This code can be specific to a merchant, a specific merchant location, or a specific transaction. Upon presenting the QR code to the user, the user photographs the code with their mobile phone. The code is then validated. For example, the code is submitted to the program server, which then confirms that the QR code is associated with the merchant.

As another example, the mobile device contains tamper-resistant software that stores a list of valid QR codes, but which is otherwise not accessible by the user. The mobile device may check the received QR code against its list of valid codes stored internally. As will be appreciated, such embodiments may work with other types of codes or keys that may be received from a merchant, in various fashions (e.g., via NFC or Bluetooth).

### Receipt Code

According to some embodiments, a unique, random code is generated and printed on a user's receipt. The user enters this code into the location based mobile application, at which time it is validated and the purchase is authenticated.

### Details Printed on a Receipt

According to some embodiments, a user enters unique details found on the receipt. These details are validated to be genuine in order to authenticate purchase. Details may include date, timestamp, address, receipt number, amount spent, and/or any other details.

### Proximity Technology

According to some embodiments, after a purchase is made, the user places their mobile phone in close proximity to a mobile device owned by the merchant. Using geolocation and GPS technologies, a location specific event occurs on both devices, which communicate with a server (e.g., the program server 104) at the same time. This validates the purchase.

### Photograph of a Receipt

According to some embodiments, the user takes a picture of their receipt after a purchase. This receipt is uploaded to the program server 104 and then validated, either algorithmically or by a human moderator.

### Photograph of Location

According to some embodiments, the user takes a photograph of the merchant with their mobile phone after a purchase is made. This photograph is used to validate their purchase.

### Wireless Router

According to some embodiments, the user connects their mobile device to a wireless router at a merchant location. This router redirects the user to a web page. The user enters uniquely identifiable information obtained only after a purchase at that merchant to validate their purchase.

### Randomized Algorithmic Code Display

According to some embodiments, the user is presented with a panel that displays random codes after a purchase is made. These codes are synced with an internet server (e.g., with the program server 104). The user enters one of these codes on their mobile device, either by typing it or photographing it. This validates the purchase.

### Blue Tooth

According to some embodiments, a user pairs their phone with a blue tooth device that is presented to them after a purchase is made. After pairing, the device transmits a code that is used to validate the purchase.

### RF Transmission

According to some embodiments, a user uses the radio frequency receiver built into their phone to receive a code from another RF device from the merchant. This validates their purchase.

### RF Receiver

According to some embodiments, a user uses the RF transmitter on their phone to send a code to another radio frequency device in the merchant location. This validates the purchase.

### Dongle

According to some embodiments, after a purchase is made, the user is presented with a dongle to attach to their device. This device, one attached, transmits a code to the application that validates the purchase.

### Internet or SMS Based Handshake

According to some embodiments, after a user makes a purchase, user initiates a validation by transmitting a message, via the internet or SMS, to another device owned by the merchant. The merchant validates this purchase by responding to the message.

### Barcode Scanning by Merchant

According to some embodiments, after a purchase is made, the user presents a unique barcode displayed on their mobile device. An internet connected device owned by the merchant scans its barcode and transmits the information to the program server 104, which authenticates the barcode and validates that a purchase was made.

### Credit Card Statements

According to some embodiments, users of a location based mobile service provide the service access to their credit card statements. Purchases are validated based on the data provided in their statements. For example, the program server 104 may see from a credit card statement that a user has engaged in a transaction with a given merchant, and may then credit that transaction towards a user goal.

### Voice Signature

According to some embodiments, a user makes a purchase, and initiates the validation process. A worker at the location says a word that has been pre-recorded and stored on a server (e.g., the program server 104). The data is transmitted to this server, and matched against the prerecorded voice signature. The match is used to validate the purchase.

### Referral Validation Using Social Networks

Various embodiments may be used to validate a referral. Various embodiments may work as follows: One person uses a location based mobile service to authenticate their presence at a given merchant location. This service integrates with Facebook, or any other social network, and records some identifiable information. This initiates a window of time, which could range anywhere from seconds to years, during which a referral can take place. A second user then comes to the merchant, makes a purchase, and validates the purchase using a location based mobile service. This service then queries the social network, or social graph data stored on any server, to determine if any of that user's friends on said social network have confirmed their presence, or a purchase, within the time window. If they have, a referral is validated. This referral can be rewarded among many friends, or just one. The user can also be asked to identify the referrer from a list of friends who have validated their presence or transaction at that location within the time window.

In various embodiments, a first user may refer a second user that is a friend of a friend, or a friend of a friend of a friend, etc. Thus, in various embodiments, two users need not be directly connected within a social network for a referral to take place, but may instead be one or more steps removed from one another.

At step 1528, the program server 104 may determine that the first transaction counts towards accomplishment of the goal by the first user. Based on one or more details of the transaction (e.g., merchant, price, product or service), the program server 104 may determine that the transactions counts towards the goal. The program server 104 may thus determine that the user is entitled to an additional punch, or other indication or mark of progress towards accomplishment of the goal.

In various embodiments, the user's mobile device may separately track the user's progress towards the goal. In various embodiments, the user's mobile device may directly count the first transaction towards the progress of the goal, or may await a confirmation from the program server 104 that the transaction counts.

The user's mobile device may render some indication or other representation of the user's progress. The rendering may include an animation of a card being punched, of a horse moving along a track, of a bucket filling, of a climber moving up a mountain, and so on.

At step 1532, the program server 104 may determine, based on the occurrence of the first transaction, a first progress of the first user towards accomplishment of the goal. The program server may update a prior progress to a new progress based on the first transaction. For example, if the prior progress was 7 punches, then the new progress may be 8 punches.

At step 1536, the program server 104 may determine, based on the first progress and the first transaction, that the first user has accomplished the goal. For example, if the user's progress is 8 punches, and the goal is to receive 8 punches, then the user has accomplished his goal. The user may now be eligible to receive a reward based on having accomplished the goal.

In some embodiments, the program server 104 may provide the user with a code, or redemption code, that may be used by the user to prove (e.g., to prove to the merchant) that he is entitled to the reward.

At step 1540, the program server 104 may determine a redemption code. The redemption code may be any numeric code, alphanumeric code, symbolic code, pictorial code, or any other code, as will be appreciated. The code may be designed so that it cannot easily be falsified or independently derived, in some embodiments. In some embodiments, the code may be unique. The program server 104 may come up with the code in various ways, as will be appreciated. For example, the program server may randomly generate the code using a random number generator.

At step 1544, the program server 104 may transmit an indication of the redemption code to the merchant. The redemption code may be transmitted to the merchant device, in some embodiments. With the redemption code in hand, the merchant device may be able to check any purported codes submitted by users against the redemption code. Only codes submitted by a user that match an existing (and previously unused) redemption code may entitle the user to receive a reward.

At step 1548, the program server 104 may determine a reward associated with the goal. For example, the program server may determine that it is a free golf lesson that is the reward associated with the goal. The reward may be determined by reference to rewards database 232, whereby the goal is represented in criteria field 916, in some embodiments. In some embodiments, having determined the reward, the program server 104 may transmit an indication of the reward to the user mobile device. This may motivate the user to go obtain the reward.

At step 1552, the program server 104 may transmit an indication of the redemption code to the first user device. Thus, the first user may now have the means to obtain his reward. The user may bring the redemption code to the merchant, allow the merchant to verify the validity of the redemption code, and then receive his reward.

### SOME EMBODIMENTS

The following are embodiments, not claims:

B. A device comprising:
a communications port;
a processor; and
a memory, in which the memory stores instructions that, when executed, cause the processor to be operable to:
   register a first user;
   register a merchant;
   determine a goal associated with the merchant;
   determine a reward associated with the goal;
   receive an indication of a first transaction from a first user device;
   determine that the first transaction occurred between the first user and the merchant;
   determine that the first transaction counts towards accomplishment of the goal by the first user;
   determine, based on the occurrence of the first transaction, a first progress of the first user towards accomplishment of the goal;
   determine, based on the first progress and the first transaction, that the first user has accomplished the goal;
   determine a redemption code;
   transmit an indication of the redemption code to the merchant; and
   transmit an indication of the redemption code to the first user device.

In various embodiments, the first user's progress towards his goal is updated based on his referral of a second user. In some embodiments, the referral by the first user is inferred, e.g., because the first user is the only connection of the second user in a social network, or the only connection of the second user that is also part of the loyalty system.

B.xx The device of embodiment B in which the processor is further operable to:
register a second user;
receive an indication of a second transaction from a second user device;
determine that the second transaction was between the second user and the merchant;
determine that the first user referred the second user to the merchant; and
update, based on the indication that the first user referred the second user, a progress of the first user from the first progress to a second progress, in which the second progress brings the first user closer to the accomplishment of the goal.

B.xx.1 The device of embodiment B.xx in which, in determining that the first user referred the second user to the merchant, the processor is operable to determine that the first user is the only connection of the second user within a social network.

B.xx.2 The device of embodiment B.xx in which, in determining that the first user referred the second user to the merchant, the processor is operable to determine that the first user is the only person that is connected to the second user within a social network, and also is registered with the device.

B.xx.3 The device of embodiment B.xx in which, in determining that the first user referred the second user to the merchant, the processor is operable to determine that the first user is connected to the second user within a social network, and is also the most recent user to visit the merchant.

B.xx.4 The device of embodiment B.xx in which, in determining that the first user referred the second user to the merchant, the processor is operable to randomly select the first user from among users who have visited the merchant.

B.xx.4 The device of embodiment B.xx in which, in determining that the first user referred the second user to the merchant, the processor is operable to determine that the first user visited the merchant, and that all users who have visited the merchant are deemed to have referred the second user to the merchant.

In some embodiments, the first user's progress towards his goal is updated based on his referral of a second user.

B.14 The device of embodiment B in which the processor is further operable to:
register a second user;
receive an indication of a second transaction from a second user device;
determine that the second transaction was between the second user and the merchant;
receive, from the second user device, an indication that the first user referred the second user to the merchant; and
update, based on the indication that the first user referred the second user, a progress of the first user from the first progress to a second progress, in which the second progress brings the first user closer to the accomplishment of the goal.

Various embodiments pertain to a social network or social networks that store relationships like ‘friends’ between individuals. Social networks may include Facebook, etc. In various embodiments, the second user indicates who referred him/her from a list of friends presented to the second user, where such friends belong to the loyalty/rewards system.

B.14.1 The device of embodiment B.14 in which the processor is further operable to:
access a social network to which the second user belongs;
determine a first set of connections of the second user on the social network;
determine a second set of connections constituting a subset of the first set of connections that are also registered users with the device; and
transmitting to the second user device indications of the second set of connections.

In various embodiments, the second user selects the first user from among a list of the second user's friends that are also part of the loyalty system.

B.14.1 The device of embodiment B.14 in which, in receiving an indication that the first user referred the second user, the processor is operable to:
receive, from the second user device, a selection of the first user from among the second set of connections.

In various embodiments, it will be appreciated that the second user may be able to choose zero, one, or more than one other users as referrers.

B.14.1.2 The device of embodiment B.14 in which the social network is Facebook, and in which the first set of connections constitute friends of the second user on Facebook.

In various embodiments, program server 104 may provide a graphical representation of the referrals, e.g., to the merchant.

B.14.2 The device of embodiment B.14 in which the processor is further operable to:
determine, based on the first transaction, a total number of transactions that have occurred between registered users and the merchant; and
transmitting to a merchant device an indication of the total number of transactions.

B.14.m The device of embodiment B.14 in which the processor is further operable to:
determine, based on the first transaction, a total number of additional transactions that have occurred between registered users and the merchant; and
transmitting to a merchant device an indication of the total number of transactions.

B.14.2.1 The device of embodiment B.14.2 in which, in transmitting the indication of the total number of transactions, the processor is further operable to:
create a graphical rendition of the total number of transactions; and
transmit the graphical rendition to the merchant device.

B.14.2.m The device of embodiment B.14.2 in which, in transmitting the indication of the total number of transactions, the processor is further operable to:
create a the social graph of referrals showing the spread of word of mouth; and
transmit the social graph to the merchant device.

Instead of just an absolute total, the server can transmit a time series, showing transactions per month, for example.

B.14.2.2 The device of embodiment B.14.2 in which the processor is further operable to:
determine, based on the first transaction, a monthly number of transactions that have occurred between registered users and the merchant; and
transmit to a merchant device an indication of the monthly number of transactions.

It will be appreciated that, in various embodiments, the device may transmit to the merchant device an indication a weekly, daily, monthly, seasonal, yearly, etc. number of transactions.

In various embodiments, program server 104 may show the merchant an indication of how many transactions have come about because of referrals.

B.14.3 The device of embodiment B.14 in which the processor is further operable to:
determine, based on the second transaction, a total number of transactions that have occurred as a result of referrals to the merchant by registered users; and
transmit to a merchant device an indication of the total number of referrals.

B.13 The device of embodiment B in which the first user device is a mobile phone.

B.yy The device of embodiment B in which the first user device is a desktop computer running a browser.

In some embodiments, the first user must explicitly elect or ask for his transaction to be tracked. B.12 The device of embodiment B in which the processor is further operable to receive an indication from a first user of a desire to track a first transaction.

In some embodiments, the server may further confirm the transaction by receiving from a merchant device (e.g., a POS system), an indication that the transaction has occurred. B.11 The device of embodiment B in which the processor is further operable to receive an indication of the first transaction from a device of the merchant.

B.11.1 The device of embodiment B in which the processor is further operable to receive an indication of the first transaction from a point-of-sale terminal of the merchant.

In some embodiments, the merchant may have some limits on a loyalty program. For example, the merchant may wish to only give away so many meals in one month, or to only have so many people participating.

B.10 The device of embodiment B in which the processor is further operable to determine a limitation on the number of times that the goal may be accomplished.

B.10.1 The device of embodiment B.10 in which, in determining a limitation on the number of times that the goal may be accomplished, the processor is operable to determine a maximum number of users that may pursue the goal at a given point in time.

B.10.2 The device of embodiment B.10 in which, in determining a limitation on the number of times that the goal may be accomplished, the processor is operable to determine a maximum number of times the goal may be achieved in a given period of time.

B.10.3 The device of embodiment B.10 in which, in determining a limitation on the number of times that the goal may be accomplished, the processor is operable to determine a maximum number of times the goal may be achieved by the first user in a given period of time.

B.9 The device of embodiment B in which the processor is further operable to:
receive an indication that the first user has used the redemption code to obtain the reward from the merchant;
record in memory the fact that the first user has obtained the reward; and
set a progress of the user to a second progress, wherein the second progress corresponds to an initial state of the first user towards accomplishment of the goal.

B.8 The device of embodiment B in which, in determining the redemption code, the processor is operable to generate a unique sequence of characters.

The server may keep track of the first user's progress by incrementing a tally of the number of transactions in which the first user has engaged with this merchant.

B.7 The device of embodiment B in which, in determining a first progress of the first user towards accomplishment of the goal, the processor is operable to increment by one a tally of the number of transactions in which the first user has engaged with the merchant.

The server may verify that the transaction is greater than a certain amount in order for it to count towards the goal.

B.5 The device of embodiment B in which, in determining that the first transaction counts towards accomplishment of the goal, the processor is operable to determine that an amount of the first transaction is greater than a predetermined amount.

B.6 The device of embodiment B in which, in determining that the first transaction counts towards accomplishment of the goal, the processor is operable to determine that an item purchased in the first transaction is one of a preapproved set of items.

B.1 The device of embodiment B in which, in registering the merchant, the processor is operable to:
store a name of the merchant; and
store a location of the merchant.

B.m The device of embodiment B in which, in registering the merchant, the processor is operable to:
store a name of the merchant;
store a location of the merchant;
design a custom card for the merchant;
store the custom card;
design a custom marketing message for the merchant; and
store the custom marketing message.

B.2 The device of embodiment B in which, in determining a goal associated with the merchant, the processor is operable to receive the goal from the merchant via the communications port.

B.3 The device of embodiment B in which, in determining a goal associated with the merchant, the processor is operable to determine at least one of:
(a) a number of transactions in which the first user must engage with the merchant;
(b) a cumulative monetary amount the first user must pay the merchant over the course of one or more transactions;
(c) a number of transactions of a particular type in which the first user must engage with the merchant;
(d) a number of transactions for a particular product in which the first user must engage with the merchant;
(e) a number of transactions for a particular category of meal in which the first user must engage with the merchant;
(f) a number of transactions in which the first user must engage with the merchant, in which each of the transactions must exceed a certain monetary amount;
(g) a number of transactions in which the first user must engage with the merchant, in which the total of the transactions must exceed a certain monetary amount;
(h) a number of transactions in which people referred by the first user must engage with the merchant;
(i) a number of transactions in which friends of the first user must engage with the merchant; and
(j) a number of transactions in which either the first user or people referred by the first user must engage with the merchant.

B.4 The device of embodiment B in which, in receiving an indication of a first transaction from a first user device, the processor is operable to receive at least one of:
(a) an image of a receipt;
(b) location data reported by the first user device;
(c) a date;
(d) a time;
(e) an item purchased;
(f) a purchase amount;
(g) an indication of a form of payment employed by the first user;
(h) a credit card number of a credit card used by the first user;
(i) a debit card number of a debit card used by the first user;
(j) a portion of a credit card number of a credit card used by the first user; and
(k) a merchant at which the first transaction occurred.

A. A device comprising:
a camera;
a sensor;
a display;
an input module;
a processor; and
a memory, in which the memory stores instructions that, when executed, cause the processor to be operable to:
   receive an indication from a user of a desire to track a transaction;
   determine location data via the sensor;
   determine a location from the location data;
   direct the camera to capture a first image of a receipt;
   store the first image of the receipt in the memory;
   determine that the receipt is genuine;
   determine that the user has completed a valid transaction based on at least one of the first image and the location;
   store a record of the transaction;
   determine a goal;
   determine, based on the transaction, a progress towards the goal;
   direct the display to depict an indication of the progress towards the goal;
   determine that the goal has been reached;
   determine a redemption code; and
   direct the display to show the redemption code.

A.ww The device of embodiment A, in which, in determining that the receipt is genuine, the processor is operable to scan from a receipt one or more of: a location, a business name, a date, a timestamp, a receipt number, a portion of a credit card number, a last four digits of a credit card number, an amount spent, a user name, and a logo.

A.ww The device of embodiment A, in which, in determining that the receipt is genuine, the processor is operable to scan from a receipt a location, a name, a date, a timestamp, a receipt number, and an amount spent.

A.xx The device of embodiment A further comprising a global positioning system.

A.yy The device of embodiment A further comprising a communication module capable of achieving connectivity with the Internet.

A.zz The device of embodiment A in which the device is a desktop computer.

In various embodiments, a redemption code may be shown in the form of a bar code.

A.19 The device of embodiment A, in which, in directing the display to show the redemption code, the processor is operable to direct the display to show the redemption code in the form of a bar code.

In various embodiments, a redemption code may be shown in the form of an alphanumeric code.

A.19 The device of embodiment A, in which, in directing the display to show the redemption code, the processor is operable to direct the display to show the redemption code in the form of an alphanumeric code.

A.17 The device of embodiment A, in which, in determining a redemption code, the processor is operable to receive from a server an indication of a redemption code.

A.18 The device of embodiment A, in which, in determining a redemption code, the processor is operable to retrieve from memory a redemption code associated with the accomplishment of the goal.

A.16 The device of embodiment A, in which, in determining that the goal has been reached, the processor is operable to determine that the progress towards the goal constitutes all the requirements of goal.

In various embodiments, once a transaction is determined to be valid, the user's phone can show a graphical animation of the punch process—e.g., a puncher punching out a hole in a card. Other indications might include e.g., a depiction of a racecar going around a track and getting closer to the finish line.

A.15 The device of embodiment A, in which, in directing the display to depict an indication of the progress towards the goal, the processor is operable to perform at least one of the following:
(a) direct the display to show an animation of a hole being punched from a punch card;
(b) direct the display to show an animation of a racecar moving closer to a finish line; and
(c) direct the display to show pie chart with a proportion of the chart filled in corresponding towards the progress towards the goal.
(d) direct the display to show a text indication of the progress towards the goal.

Progress towards the goal may include a fraction of the goal complete, a percentage complete, a proportion complete, etc.

A.14 The device of embodiment A, in which, in determining a progress towards the goal, the processor is operable to perform at least one of the following:
(a) determine a percentage of the goal that has been completed;
(b) determine a total number of transactions counting towards the goal that have been completed;
(c) determine a total number of transactions counting towards the goal that remain to be completed;
(d) determine a proportion of the goal that has been completed;
(e) determine a total amount that has been spent and which counts towards the goal;
(f) determine a total amount that remains to be spent in order to accomplish the goal; and
(g) receive from a server an indication the progress towards the goal.

In various embodiments, a user may be authenticated. For example, the system may want to make sure it is the user participating in a transaction, and not just the user's friend borrowing his cell phone.

A.w The device of embodiment A in which the processor is further operable to verify the identity of the user.

A.w.1 The device of embodiment A.w in which, in verifying the identity of the user, the processor is further operable to:
receive first biometric information via the input module; and
determine that the first biometric information matches predetermined biometric information of the user.

In various embodiments, the user identity can be verified by means of a password. A.w.2 The device of embodiment A.w in which, in verifying the identity of the user, the processor is further operable to:
receive a password via the input module; and
determine that the password matches a password associated with the user.

In various embodiments, a type of goal is that there should be a certain number of total transactions, such as 10.

A.12 The device of embodiment A in which, in determining the goal, the processor is operable to determine a total number of transactions required.

In various embodiments, a type of goal is that there should be a certain total amount spent.

A.13 The device of embodiment A in which, in determining the goal, the processor is operable to determine a cumulative amount of money to be spent.

Even if the receipt is genuine, the user may not have completed a valid transaction. For example, there may be a minimum purchase required.

A.8 The device of embodiment A in which, in determining that the user has completed a valid transaction, the processor is operable to:
determine an amount of the transaction; and
determine that the amount of the transaction exceeds a predetermined minimum amount.

A.9 The device of embodiment A in which, in determining that the user has completed a valid transaction, the processor is operable to:
transmit information about the transaction to a server; and
receive from the serve an indication that the transaction is valid.

In various embodiments, a transaction is valid if it is a particular item. For example, only purchases of entrees may count towards a goal.

A.10 The device of embodiment A in which, in determining that the user has completed a valid transaction, the processor is operable to:
determine an item that the user has purchased in the transaction; and
determine that the item is among a predetermined set of approved items.

In various embodiments, validating a transaction may include matching the user's location to that of the merchant.

A.11 The device of embodiment A in which, in determining that the user has completed a valid transaction, the processor is operable to:
determine an identity of a merchant based on the image of the receipt;
determine a location of the merchant based on the identity of the merchant; and
determine that the location of the merchant corresponds to the location determined from the location data.

In various embodiments, the merchant's location may be found based on its name, e.g., by looking up the merchant's address or location in a database.

A.11.1 The device of embodiment A in which, in determining the location of the merchant, the processor is operable to query a database that associates merchant identities with merchant locations.

In some embodiments, it must be determined if the receipt is genuine or not. For example, is it really from the merchant?

A.7 The device of embodiment A in which, in determining that the receipt is genuine, the processor is operable to perform at least one of:
(a) transmit the first image of the receipt to a server and receive from the server an indication that the receipt is genuine;
(b) determine a set of alphanumeric characters printed on the receipt and compare the set of alphanumeric characters to a predetermined set of alphanumeric characters;
(c) determine a code printed on the receipt and compare the code to a predetermined code;
(d) determine a logo printed on the receipt and compare the logo to a predetermined logo;
(e) determine a color of a substrate of the receipt;
(e) determine a color of characters printed on the receipt;
(f) determine a font of characters printed on the receipt; and
(g) determine a font size of characters printed on the receipt.

In some embodiments, optical character recognition (OCR) may be used to derive information from a receipt.

A.7.1 The device of embodiment A.7 in which, in determining the set of alphanumeric characters, the processor is operable to determine a set of alphanumeric characters printed on the receipt using optical character recognition, and compare the set of alphanumeric characters to a predetermined set of alphanumeric characters.

In various embodiments, OCR may be performed on the client side (e.g., on the user mobile device) and/or on the server side (e.g., on the program server 104). If OCR happens on client side then the user may correct the information and the corrected information may be submitted to the program server along with the receipt image.

In some embodiments, one way to determine if the receipt is genuine is to see if the credit card number on the receipt matches the known credit card number of the user.

A.7.2 The device of embodiment A.7 in which, in determining the set of alphanumeric characters, the processor is operable to:
determine a set of alphanumeric characters representing a portion of a charge card number for a charge card used in the transaction; and
compare the set of alphanumeric characters to a predetermined charge card number for a charge card belonging to the user.

In some embodiments, ways to see if the receipt is genuine may include checking the location, address, date, timestamp, receipt number, and/or amount spent on the receipt.

In various embodiments, a mobile device may provide feedback to indicate whether its camera is properly focused on a receipt, or is looking at something else. For instance, a user may point a camera once, but the camera may not be pointed properly at a receipt. Therefore, the mobile device may reject an initial image. Only when the camera is pointing at the receipt does the mobile device actually keep and analyze the image of the receipt. In some embodiments, the mobile device may provide feedback to the user (e.g., an audible one, e.g., a flashing icon) to indicate that the user has successfully pointed the mobile device's camera at a receipt, or has not yet done so.

A.6 The device of embodiment A in which, in directing the camera to capture the first image, the processor is operable to:
direct the camera to capture a second image;
determine that the second image is not an image of the receipt;
direct the camera to capture the first image after determining that the second image is not an image of the receipt; and
determine that the first image is an image of the receipt.

A.6.1 The device of embodiment A.6 in which, in determining that the second image is not an image of the receipt, the processor is operable to perform at least one of:
(a) analyze the second image for the presence of alphanumeric characters;
(b) analyze the second image for the presence of a bar code;
(c) analyze the second image for the presence of numeric characters;
(d) analyze the second image for presence of a name of a merchant; and
(e) analyze the second image for presence of a name of a logo.

A.6.m The device of embodiment A.6 in which, in determining that the second image is not an image of the receipt, the processor is operable to perform at least one of:
(a) analyze the second image for the presence of a location;
(b) analyze the second image for the presence of a date;
(c) analyze the second image for the presence of a time stamp;
(d) analyze the second image for presence of a name of a receipt number; and
(e) analyze the second image for presence of an amount spent.

A.q The device of embodiment A in which the input module comprises at least one of:
(a) a keypad;
(b) a numeric keypad;
(c) an alphanumeric keypad;
(d) a button;
(e) a touch sensitive screen;
(f) a microphone;
(g) a trackball;
(h) a track wheel;
(j) a touch pad;
(k) an accelerometer;
(l) a gyroscope;
(m) an orientation sensor;
(n) the camera; and
(o) the sensor.

A.r The device of embodiment A further comprising a wireless communication module.

A.r.1 The device of embodiment A.r in which the wireless communication module comprises an antenna.

A.r.2 The device of embodiment A.r in which the wireless communication module comprises a cellular band transceiver.

A.r.3 The device of embodiment A.r in which the wireless communication module comprises an antenna tuned to receive at least one of: (a) Bluetooth; and (b) Wi-Fi.

There may be various ways by which the user indicates a desire to track a transaction. For example, the user presses a button.

A.4 The device of embodiment A in which, in receiving the indication from the user, the processor is further operable to receive a user input via the input module.

In various embodiments, a user provides an input to open the loyalty program (e.g., select the particular application), and then another input to record a transaction.

A.5 The device of embodiment A in which, in receiving the indication from the user, the processor is further operable to:
receive a first user input via the input module to activate a loyalty program; and
receive a second user input via the input module to track the transaction.

A.5.1 The device of embodiment A in which, in receiving the indication from the user, the processor is further operable to:
receive a third user input via the input module to capture the first image of the receipt.

In various embodiments, various steps may be taken, either individually or in conjunction, in order to validate a transaction.

A.3 The device of embodiment A in which, in determining if the user has completed a valid transaction, the processor is operable to perform at least one of:
(a) determine that the receipt is authentic;
(b) determine that the receipt has not been previously used by any user;
(c) determine that the transaction amount is greater than a predetermined amount;
(d) determine that a first date of the transaction falls within a predetermined range;
(e) determine a second date on which the first image was captured; determine a third date as reported on the receipt; and determining that the second date is within a predetermined number of days of the third date;

A.1 The device of embodiment A, in which location data is determined using a global positioning system.

A.v The device of embodiment A, in which location data is determined using wireless signals from a cellular tower.

A.2 The device of embodiment A, in which, in depicting a progress towards a goal, the processor depicts an animation of a hole being punched.

A.x The device of embodiment A in which the transaction is a purchase at a merchant.

A.x.1 The device of embodiment A.x in which the transaction is a purchase of at least one food item at a restaurant.

A.x.m The device of embodiment A.x in which the transaction is a purchase of at least one product or service at the merchant.

It will be appreciated that, whereas embodiments described herein have made reference to “merchants” and “businesses”, other types of parties or entities are also contemplated. For example, a participant with the program server 104 may include a non-profit organization, a government association, a club, a civic organization, or any other group, entity, or organization. In some embodiments, a participant providing a product or server may be an individual and not part of any large entity or organization.

It will be appreciated that various embodiments are not limited to the foregoing description and figures, and that various alternatives are also contemplated.

Applicants claim:

1. A device comprising:
a communications port;
a processor; and
a memory, in which the memory stores instructions that, when executed, cause the processor to be operable to:
register a first user;
register a merchant;
determine a goal associated with the merchant;
determine a reward associated with the goal;
receive an indication of a first transaction from a first user device;
determine that the first transaction occurred between the first user and the merchant;
determine that the first transaction counts towards accomplishment of the goal by the first user;
determine, based on the occurrence of the first transaction, a first progress of the first user towards accomplishment of the goal;
determine, based on the first progress and the first transaction, that the first user has accomplished the goal;
determine a redemption code;
transmit an indication of the redemption code to the merchant; and
transmit an indication of the redemption code to the first user device.

2. The device of claim 1 in which the processor is further operable to:
register a second user;
receive an indication of a second transaction from a second user device;
determine that the second transaction was between the second user and the merchant;
determine that the first user referred the second user to the merchant; and
update, based on the indication that the first user referred the second user, a progress of the first user from the first progress to a second progress, in which the second progress brings the first user closer to the accomplishment of the goal.

3. The device of claim 2 in which, in determining that the first user referred the second user to the merchant, the processor is operable to determine that the first user is the only connection of the second user within a social network.

4. The device of claim 2 in which, in determining that the first user referred the second user to the merchant, the processor is operable to determine that the first user is the only person that is connected to the second user within a social network, and also is registered with the device.

5. The device of claim 2 in which, in determining that the first user referred the second user to the merchant, the processor is operable to determine that the first user is connected to the second user within a social network, and is also the most recent user to visit the merchant.

6. The device of claim 2 in which, in determining that the first user referred the second user to the merchant, the processor is operable to randomly select the first user from among users who have visited the merchant.

7. The device of claim 2 in which, in determining that the first user referred the second user to the merchant, the processor is operable to determine that the first user visited the merchant, and that all users who have visited the merchant are deemed to have referred the second user to the merchant.

8. The device of claim 1 in which the processor is further operable to:
register a second user;
receive an indication of a second transaction from a second user device;
determine that the second transaction was between the second user and the merchant;
receive, from the second user device, an indication that the first user referred the second user to the merchant; and
update, based on the indication that the first user referred the second user, a progress of the first user from the first progress to a second progress, in which the second progress brings the first user closer to the accomplishment of the goal.

9. The device of claim 8 in which the processor is further operable to:
access a social network to which the second user belongs;
determine a first set of connections of the second user on the social network;
determine a second set of connections constituting a subset of the first set of connections that are also registered users with the device; and
transmitting to the second user device indications of the second set of connections.

10. The device of claim 9 in which, in receiving an indication that the first user referred the second user, the processor is operable to:
receive, from the second user device, a selection of the first user from among the second set of connections.

11. The device of claim 9 in which the social network is Facebook, and in which the first set of connections constitute friends of the second user on Facebook.

12. The device of claim 8 in which the processor is further operable to:
determine, based on the first transaction, a total number of transactions that have occurred between registered users and the merchant; and
transmitting to a merchant device an indication of the total number of transactions.

13. The device of claim 12 in which, in transmitting the indication of the total number of transactions, the processor is further operable to:
create a graphical rendition of the total number of transactions; and
transmit the graphical rendition to the merchant device.

14. The device of claim 1 in which the first user device is a mobile phone.

15. The device of claim 1 in which the first user device is a desktop computer running a browser.

16. The device of claim 1 in which the processor is further operable to receive an indication from a first user of a desire to track a first transaction.

17. The device of claim 1 in which, in receiving an indication of a first transaction from a first user device, the processor is operable to receive at least one of:
(a) an image of a receipt;
(b) location data reported by the first user device;
(c) a date;
(d) a time;
(e) an item purchased;
(f) a purchase amount;
(g) an indication of a form of payment employed by the first user;
(h) a credit card number of a credit card used by the first user;
(i) a debit card number of a debit card used by the first user;
(j) a portion of a credit card number of a credit card used by the first user; and
(k) a merchant at which the first transaction occurred.

18. A. A device comprising:
a camera;
a sensor;
a display;
an input module;
a processor; and
a memory, in which the memory stores instructions that, when executed, cause the processor to be operable to:
receive an indication from a user of a desire to track a transaction;
determine location data via the sensor;
determine a location from the location data;
direct the camera to capture a first image of a receipt;
store the first image of the receipt in the memory;
determine that the receipt is genuine;
determine that the user has completed a valid transaction based on at least one of the first image and the location;
store a record of the transaction;
determine a goal;
determine, based on the transaction, a progress towards the goal;
direct the display to depict an indication of the progress towards the goal;
determine that the goal has been reached;
determine a redemption code; and
direct the display to show the redemption code.

19. The device of claim 18, in which, in determining that the receipt is genuine, the processor is operable to scan from a receipt one or more of: a location, a business name, a date, a timestamp, a receipt number, a portion of a credit card number, a last four digits of a credit card number, an amount spent, a user name, and a logo.

20. The device of claim 18, in which, in determining that the receipt is genuine, the processor is operable to scan from a receipt a location, a name, a date, a timestamp, a receipt number, and an amount spent.

21. The device of claim 18 further comprising a global positioning system.

22. The device of claim 18 further comprising a communication module capable of achieving connectivity with the Internet.

23. The device of claim 18 in which the device is a desktop computer.

24. The device of claim 18, in which, in directing the display to depict an indication of the progress towards the goal, the processor is operable to perform at least one of the following:
(a) direct the display to show an animation of a hole being punched from a punch card;
(b) direct the display to show an animation of a racecar moving closer to a finish line; and
(c) direct the display to show pie chart with a proportion of the chart filled in corresponding towards the progress towards the goal.
(d) direct the display to show a text indication of the progress towards the goal.

25. The device of claim 18, in which, in determining a progress towards the goal, the processor is operable to perform at least one of the following:
(a) determine a percentage of the goal that has been completed;
(b) determine a total number of transactions counting towards the goal that have been completed;
(c) determine a total number of transactions counting towards the goal that remain to be completed;
(d) determine a proportion of the goal that has been completed;
(e) determine a total amount that has been spent and which counts towards the goal;
(f) determine a total amount that remains to be spent in order to accomplish the goal; and
(g) receive from a server an indication the progress towards the goal.

26. The device of claim 18 in which, in determining that the user has completed a valid transaction, the processor is operable to:
determine an amount of the transaction; and
determine that the amount of the transaction exceeds a predetermined minimum amount.

27. The device of claim 18 in which, in determining that the user has completed a valid transaction, the processor is operable to:
transmit information about the transaction to a server; and
receive from the serve an indication that the transaction is valid.

28. The device of claim 18 in which, in determining that the user has completed a valid transaction, the processor is operable to:
determine an item that the user has purchased in the transaction; and
determine that the item is among a predetermined set of approved items.

29. The device of claim 18 in which, in determining that the user has completed a valid transaction, the processor is operable to:
determine an identity of a merchant based on the image of the receipt;
determine a location of the merchant based on the identity of the merchant; and
determine that the location of the merchant corresponds to the location determined from the location data.

30. The device of claim 18 in which, in determining the location of the merchant, the processor is operable to query a database that associates merchant identities with merchant locations.

31. The device of claim 18 in which, in determining that the receipt is genuine, the processor is operable to perform at least one of:
(a) transmit the first image of the receipt to a server and receive from the server an indication that the receipt is genuine;
(b) determine a set of alphanumeric characters printed on the receipt and compare the set of alphanumeric characters to a predetermined set of alphanumeric characters;
(c) determine a code printed on the receipt and compare the code to a predetermined code;
(d) determine a logo printed on the receipt and compare the logo to a predetermined logo;
(e) determine a color of a substrate of the receipt;
(e) determine a color of characters printed on the receipt;
(f) determine a font of characters printed on the receipt; and
(g) determine a font size of characters printed on the receipt.

32. The device of claim 31 in which, in determining the set of alphanumeric characters, the processor is operable to determine a set of alphanumeric characters printed on the receipt using optical character recognition, and compare the set of alphanumeric characters to a predetermined set of alphanumeric characters.

33. The device of claim 31 in which, in determining the set of alphanumeric characters, the processor is operable to:
determine a set of alphanumeric characters representing a portion of a charge card number for a charge card used in the transaction; and
compare the set of alphanumeric characters to a predetermined charge card number for a charge card belonging to the user.

34. The device of claim 18 in which, in directing the camera to capture the first image, the processor is operable to:
direct the camera to capture a second image;
determine that the second image is not an image of the receipt;
direct the camera to capture the first image after determining that the second image is not an image of the receipt; and
determine that the first image is an image of the receipt.

35. The device of claim 34 in which, in determining that the second image is not an image of the receipt, the processor is operable to perform at least one of:
(a) analyze the second image for the presence of alphanumeric characters;
(b) analyze the second image for the presence of a bar code;
(c) analyze the second image for the presence of numeric characters;
(d) analyze the second image for presence of a name of a merchant; and
(e) analyze the second image for presence of a name of a logo.

36. The device of claim 18 in which the input module comprises at least one of:
(a) a keypad;
(b) a numeric keypad;
(c) an alphanumeric keypad;
(d) a button;
(e) a touch sensitive screen;
(f) a microphone;
(g) a trackball;
(h) a track wheel;
(j) a touch pad;
(k) an accelerometer;
(l) a gyroscope;
(m) an orientation sensor;
(n) the camera; and
(o) the sensor.

37. The device of claim 18 further comprising a wireless communication module.

38. The device of claim 37 in which the wireless communication module comprises an antenna.

39. The device of claim 37 in which the wireless communication module comprises a cellular band transceiver.

40. The device of claim 37 in which the wireless communication module comprises an antenna tuned to receive at least one of: (a) Bluetooth; and (b) Wi-Fi.

41. The device of claim 18 in which, in receiving the indication from the user, the processor is further operable to receive a user input via the input module.

42. The device of claim 18 in which, in receiving the indication from the user, the processor is further operable to:
receive a first user input via the input module to activate a loyalty program; and
receive a second user input via the input module to track the transaction.

43. The device of claim 18 in which, in receiving the indication from the user, the processor is further operable to:
receive a third user input via the input module to capture the first image of the receipt.

44. The device of claim 18 in which, in determining if the user has completed a valid transaction, the processor is operable to perform at least one of:
(a) determine that the receipt is authentic;
(b) determine that the receipt has not been previously used by any user;
(c) determine that the transaction amount is greater than a predetermined amount;
(d) determine that a first date of the transaction falls within a predetermined range;
(e) determine a second date on which the first image was captured; determine a third date as reported on the receipt; and determining that the second date is within a predetermined number of days of the third date;

45. The device of claim 18, in which location data is determined using a global positioning system.

46. The device of claim 18, in which location data is determined using wireless signals from a cellular tower.

47. The device of claim 18, in which, in depicting a progress towards a goal, the processor depicts an animation of a hole being punched.

48. The device of claim 18 in which the transaction is a purchase at a merchant.

49. The device of claim 48 in which the transaction is a purchase of at least one food item at a restaurant.
